(19) United States
(12) Patent Application Publication
(10) Pub. No.: US 2006/0070881 A1
(43) Pub. Date: Apr. 6, 2006

(54) Aluminum support for planographic printing plate, its manufacturing process, and planographic printing plate material

(75) Inventor: Teruo Takada, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/239,746

(22) Filed: Sep. 30, 2005

(30) Foreign Application Priority Data
Oct. 4, 2004 (JP) 2004-291135

(51) Int. Cl. B41N 1/04

(52) U.S. Cl. 205/69

(57) ABSTRACT

Disclosed is an aluminum support for a planographic printing plate comprising an electrolytically surface-roughened aluminum plate, and a sulfuric acid anodization layer and a phosphoric acid anodization layer provided in that order on the surface-roughened surface of the surface-roughened aluminum plate, the sulfuric acid anodization layer having micro-pores with a pore size of from 8 to 15 nm and the phosphoric acid anodization layer having micro-pores with a pore size of from 40 to 100 nm, wherein the sulfuric acid anodization layer has been formed by anodizing the aluminum plate in a sulfuric acid electrolytic solution and the phosphoric acid anodization layer has been formed by anodizing the aluminum plate in a phosphoric acid electrolytic solution.

This application is based on Japanese Patent Application No. 2004-291135 filed on Oct. 4, 2004 in Japanese Patent Office, the entire content of which is hereby incorporated by reference.

### FIELD OF THE INVENTION

The present invention relates to an aluminum support for a planographic printing plate material and its manufacturing process, Sa planographic printing plate material, and an image formation process.

### BACKGROUND OF THE INVENTION

A planographic printing process is a printing process carried out employing nature such that water and oil are immiscible with each other. A planographic printing plate used in the planographic printing process has portions (hereinafter referred to as non-image portions) which receive water and repel printing ink and portions (hereinafter referred to as image portions) which repel water and receive printing ink.

An aluminum support used in a planographic printing plate (material) is required to have various properties incompatible with each other, for example, a property that hydrophilicity and water retentivity is high at non-image portions, while its adhesion to an image formation layer forming image portions is high. An aluminum support with a low hydrophilicity is likely to receive printing ink at non-image portions of printing plate during printing, resulting in so-called stain occurrence. An aluminum support with a low water retentivity is likely to produce stain at non-image portions during printing, and requires more dampening water during printing. This results in lowering of so-called dampening water tolerance.

In recent years, a CTP system, which writes digital images employing laser light directly on a planographic printing plate material, has been developed as a technique making a planographic printing plate, and put to practical use. As a laser light are used lasers emitting visible light with longer wavelength such as an Ar laser (488 nm), an FD-YAG laser (532 nm) and a high power semi-conductor laser emitting a 750 nm or longer wavelength light. In recent years, a semiconductor laser (hereinafter also referred to as violet laser), which employs materials of InGaN or ZnSe type and is capable of continuously emitting light from 350 to 450 nm, is about to be put to practical use, employing materials of InGaN or ZnSe type. A planographic printing plate material with an image formation layer adapted to the respective laser has been also developed.

An aluminum support for a planographic printing plate is generally manufactured by surface-roughening an aluminum plate surface according to a process comprising an appropriate combination of steps selected from mechanical surface-roughening, chemical etching in an acidic or basic solution, desmutting in an acidic solution, electrolytic (electrochemical) surface-roughening, anodization in an acidic solution, hydrophilization treatment, and sealing treatment.

Particularly, the electrolytic surface-roughening has been generally used as a surface roughening method of an aluminum support for a planographic printing plate, since a uniformly roughened surface is easily obtained. The electrolytic surface-roughening is ordinarily carried out in an aqueous hydrochloric acid solution or in an aqueous nitric acid solution.

Various manufacturing processes of the aluminum support for a planographic printing plate have been proposed (see, for example, Japanese Patent O.P.I. Publication Nos. 2003-39846, 2003-19877, 2003-19878, 2002-363799, and 2002-362046, and U.S. Pat. Nos. 5,122,243 and 5,186,795.). A technique preventing stain occurrence or improving printing durability is proposed in which in the anodization step after surface roughened, the total content or the content ratio of a material derived from sulfuric acid and a material derived from phosphoric acid or the amount of the anodization layer formed is appropriately adjusted to a specific range (see, for example, Japanese Patent O.P.I. Publication No. 9-169173.).

However, a planographic printing plate material, comprising an aluminum support manufactured according to these processes, and an image formation layer provided thereon, is insufficient in adhesion of the image formation layer to the support, and a planographic printing plate, which is prepared from such a planographic printing plate material according to a plate making process employing laser imagewise exposure, has problems in that printing durability is poor. Particularly when printing is carried out employing printing ink containing no VOC, the planographic printing plate provides poor printing durability or poor dampening water tolerance.

### SUMMARY OF THE INVENTION

An object of the invention is to provide a planographic printing plate material, which is suitable for laser exposure and provides high printing durability and an excellent anti-stain property, an aluminum support for the planographic printing plate material and its manufacturing process, and an image formation process..

### BRIEF DESCRIPTION OF THE DRAWING

FIG. 1 shows a schematic view of an anodization apparatus in the invention.

### DETAILED DESCRIPTION OF THE INVENTION

The above object has been attained by one of the following constitutions:

1. An aluminum support for a planographic printing plate comprising an electrolytically surface-roughened aluminum plate, and a sulfuric acid anodization layer and a phosphoric acid anodization layer provided in that order on the surface-roughened surface of the surface-roughened aluminum plate, the sulfuric acid anodization layer having micro-pores with a pore size of from 8 to 15 nm and the phosphoric acid anodization layer having micro-pores with a pore size of from 40 to 100 nm, wherein the sulfuric acid anodization layer has been formed by anodizing the aluminum plate in a sulfuric acid electrolytic solution and the phosphoric acid anodization layer has been formed by anodizing the aluminum plate in a phosphoric acid electrolytic solution.

2. The aluminum support for a planographic printing plate of item 1 above, wherein the phosphoric acid anodization layer has a thickness of from 0.1 to 0.5 μm.

3. A planographic printing plate material comprising the aluminum support of item 1 above, and provided thereon, an image formation layer.

4. A planographic printing plate material of item 3 above, wherein the image formation layer is a positive-working or negative working image formation layer.

5. The planographic printing plate material of item 4 above, wherein the image formation layer is a positive-working image formation layer.

6. The planographic printing plate material of item 4 above, wherein the image formation layer is a negative-working image formation layer.

7. The planographic printing plate material of item 6 above, wherein the negative-working image formation layer is a photopolymerizable-light sensitive layer containing a photopolymerizable monomer and an initiator.

8. The planographic printing plate material of item 3 above, wherein the image formation layer is an image formation layer capable of being developed on a printing press.

9. A process for manufacturing an aluminum support for a planographic printing plate material, the process comprising the steps of (a) electrolytically surface-roughening an aluminum plate, (b) anodizing the electrolytically surface-roughened aluminum plate in a phosphoric acid electrolytic solution, (c) treating the resulting aluminum plate in an electrolyte in an electrolyte tank while supplying electric current, and (d) further anodizing the above-treated aluminum plate in a sulfuric acid electrolytic solution.

10. The process of item 9 above, wherein the electrolyte in the electrolyte tank is a phosphoric acid solution or a sulfuric acid solution.

11. The process of item 10 above, wherein the electrolyte is a sulfuric acid solution.

12. The process of item 11 above, wherein the sulfuric acid solution has an sulfuric acid concentration of from 10 to 50% by weight.

13. The process of item 9 above, wherein treating in the step (c) is carried out at a temperature of from 25 to 50° C. at a current density of 30 from to 100 A/dm².

14. An image formation process comprising imagewise exposing to a laser the planographic printing plate material of item 3 above.

Next, the present invention will be explained in detail.

The aluminum support of the invention for a planographic printing plate is characterized in that the aluminum support comprises an electrolytically surface-roughened aluminum plate and provided thereon, a sulfuric acid-anodization layer and a phosphoric acid anodization layer in that order, wherein the sulfuric acid anodization layer has been formed by anodizing the electrolytically surface-roughened aluminum plate in a sulfuric acid electrolytic solution and the phosphoric acid anodization layer has been formed by anodizing the electrolytically surface-roughened aluminum plate in a phosphoric acid electrolytic solution. The thickness of the phosphoric acid anodization layer is preferably from 0.1 to 0.5 μm.

The aluminum support of the invention improves the adhesion property and hydrophilicity, and provides an excellent printing durability and an excellent anti-stain property.

The above aluminum support is manufactured by a manufacturing process, which comprises the steps of anodizing an electrolytically surface-roughened aluminum plate in a phosphoric acid electrolytic solution, treating the resulting aluminum plate in an electrolyte in an electrolyte tank, and further anodizing the treated aluminum plate in a sulfuric acid electrolytic solution..

(Aluminum Support)

As a substrate for the aluminum support of the planographic printing plate of the invention, an aluminum plate is used, and may be a pure aluminum plate or an aluminum alloy plate. As the aluminum alloy, there can be used various ones including an alloy of aluminum and a metal such as silicon, copper, manganese, magnesium, chromium, zinc, lead, bismuth, nickel, titanium, sodium or iron. Further, an aluminum plate manufactured by rolling can be used. A regenerated aluminum plate obtained by rolling aluminum regenerated from scrapped or recycled materials, which has recently spread, can be also used.

It is preferable that the aluminum plate for the support used in the planographic printing plate material of the invention is subjected to degreasing treatment for removing rolling oil prior to surface-roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution-such as caustic soda is used for the degreasing treatment, the resulting plate is preferably subjected to desmut treatment in an aqueous solution of an acid such as phosphoric acid, nitric acid, sulfuric acid, chromic acid, or a mixture thereof, since smut is produced on the surface of the support.

Subsequently, surface-roughening treatment is carried out. In the invention, electrolytic surface-roughening treatment is carried out in an electrolytic solution containing hydrochloric acid as a main component, employing an alternating current. However, prior to the electrolytic surface-roughening treatment in the electrolytic solution containing hydrochloric acid, electrolytic surface-roughening treatment may be carried out in an electrolytic solution containing nitric acid as a main component, employing an alternating current, or mechanical surface-roughening treatment may be carried out.

Though there is no restriction for the mechanical surface-roughening method, a brushing roughening method and a honing roughening method are preferable. The brushing roughening method is carried out by rubbing the surface of the plate with a rotating brush with a brush hair with a diameter of 0.2 to 0.8 mm, while supplying slurry in which volcanic ash particles with a particle size of 10 to 100 μm are dispersed in water to the surface of the plate. The honing roughening method is carried out by ejecting obliquely slurry with pressure applied from nozzles to the surface of the plate, the slurry containing volcanic ash particles with a particle size of 10 to 100 μm dispersed in water. Surface-roughening can be also carried out by laminating the plate surface with a sheet on the surface of which abrading particles with a particle size of from 10 to 100 μm has been coated at intervals of 100 to 200 μm and at a density of 2.5×10³ to 10×10³/cm², and then applying pressure to the laminated sheet to transfer the roughened pattern of the sheet, whereby the plate surface is roughened.

After the plate has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous solution of alkali chemicals such as sodium hydroxide is preferably used. The dissolution amount of aluminum in the plate surface is preferably 0.5 to 5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In the electrolytic surface-roughening treatment carried out in the electrolytic solution containing nitric acid (hereinafter also referred to as nitric acid electrolytic solution), voltage applied is generally from 1 to 50 V, and preferably from 5 to 30 V. The current density used can be selected from the range from 10 to 200 A/dm², and is preferably from 20 to 150 A/dm²₄ The quantity of electricity can be selected from the range of from 100 to 5000 C/dm², and is preferably 100 to 1500 C./dm². The temperature during the electrolytic surface-roughening treatment may be in the range of from 10 to 50° C., and is preferably from 15 to 45° C. The nitric acid concentration in the nitric acid electrolytic solution is preferably from 1 to 30 g/liter. It is possible to optionally add, to the nitric acid electrolytic solution, nitrates, chlorides, amines, aldehydes, phosphoric acid, chromic acid, boric acid, acetic acid, oxalic acid or aluminum salts.

After the aluminum plate has been subjected to electrolytic surface-roughening treatment in the electrolytic solution containing nitric acid, it is preferably dipped in an acid or an aqueous alkali solution in order to remove abrasives and aluminum dust, etc., which have been produced in the plate surface. Examples of the acid include sulfuric acid, persulfuric acid., hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the plate surface is preferably 0.5 to 1.5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization.

In electrolytic surface-roughening treatment carried out in the electrolytic solution containing hydrochloric acid (hereinafter also referred to as hydrochloric acid electrolytic solution), the hydrochloric acid concentration of the hydrochloric acid electrolytic solution used is from 5 to 20 g/liter, and preferably from 6 to 15 g/liter. The current density supplied is in the range from 15 to 200 A/dm², and preferably from 20 to 150 A/dm². The quantity of electricity is in the range of from 400 to 2000 C/dm², and preferably 500 to 1500 C/dm². Frequency is preferably in the range of from 40 to 150 Hz. The temperature during the electrolytic surface-roughening treatment may be in the range of from 10 to 50° C., and is preferably from 15 to 45° C. It is possible to optionally add, to the hydrochloric acid electrolytic solution, nitrates, chlorides, amines, aldehydes, phosphoric acid, chromic acid, boric acid, acetic acid, oxalic acid or aluminum salts.

After the aluminum plate has been subjected to electrolytic surface-roughening treatment in the electrolytic solution containing hydrochloric acid, it is preferably dipped in an acid or an aqueous alkali solution in order to remove aluminum dust, etc., which have been produced in the plate surface. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, a phosphoric acid or sodium hydroxide aqueous solution is preferably used. The dissolution amount of aluminum in the plate surface is preferably 0.5 to 1.5 g/m². After the plate has been dipped in the aqueous alkali solution, it is preferable for the plate to be dipped in an acid such as phosphoric acid, nitric acid, sulfuric acid and chromic acid, or in a mixed acid thereof, for neutralization. The aluminum plate after the electrolytic surface-roughening treatment is subjected to anodizing treatment.

In the anodizing treatment in the invention, the electrolytically surface roughened aluminum plate is anodized in an electrolytic solution containing phosphoric acid (hereinafter also referred to as phosphoric acid electrolytic solution), treated in an electrolyte in an electrolyte tank, and further anodized in an electrolytic solution containing sulfuric acid (hereinafter also referred to as sulfuric acid electrolytic solution).

In the above anodizing treatment, the electrolytically surface roughened aluminum plate is anodized in the phosphoric acid electrolytic solution to form a phosphoric acid anodization layer on the surface of the surface-roughened side, treated in an electrolyte in an electrolyte tank, and further anodized in the sulfuric acid electrolytic solution to form a sulfuric acid anodization layer on the surface of the surface-roughened side. In the anodization layers formed as above, the phosphoric acid anodization layer, which is formed earlier, is formed on the sulfuric acid anodization layer to be formed later. This is due to the fact that since an anodization layer grows on the surface of an aluminum plate (not on an anodization layer), an earlier formed anodization layer is formed on a later formed anodization layer.

In the anodizing treatment carried out in the phosphoric acid electrolytic solution, the phosphoric acid concentration of the phosphoric acid electrolytic solution is preferably from 5 to 50% by weight, and more preferably from 10 to 35% by weight. The temperature of the phosphoric acid electrolytic solution is preferably from 10 to 50° C. Voltage applied is preferably not less than 18 V, and more preferably not less than 20 V. Current density applied is preferably from 1 to 30 A/dm². Quantity of electricity is preferably from 100 to 500 C/dm².

A sulfuric acid solution or a phosphoric acid solution is preferably used as the electrolyte in the electrolyte tank. An anode is provided in the electrolyte tank and the aluminum plate surface functions as a cathode, wherein hydrogen is mainly generated. Generally, electric current is supplied between the anode of the electrolyte tank and the cathode of anodization tanks through a direct current power supply. When there is no electrolyte tank, anodizing cannot be carried out. Use of conductive material (for example, metal), in which the aluminum plate is brought into contact the conductive material so that electric current flows, is considered instead of the electrolyte tank. However, since an anodization layer firstly produced on the aluminum plate surface through anodization treatment is an insulation layer, electric current does not flow by contact of the aluminum plate with the conductive material. Therefore, the electrolyte tank as described above is generally employed. In order to save electric energy from the industrial viewpoint, lower voltage for electrolysis is applied where electrolysis is carried out at high temperature in an acid solution with high acid concentration. The phosphoric acid concentration of the phosphoric acid solution or the sulfuric acid concentration the sulfuric acid solution in the electrolyte tank is preferably from 10 to 50% by weight, and more preferably from 20 to 35% by weight. Temperature of the electrolyte is preferably from 25 to 50° C. Voltage applied between the anode and the cathode is preferably not more than 10 V, and more preferably not more than 4 V. Current density supplied is preferably from 30 to 100 A/dm².

The electrolyte tank is preferably a tank containing the sulfuric acid solution.

In the anodizing treatment carried out in the sulfuric acid electrolytic solution, the sulfuric acid concentration of the sulfuric acid electrolytic solution is preferably from 5 to 50% by weight, and more preferably from 10 to 40% by weight. The temperature of the sulfuric acid solution is preferably from 10 to 50° C. Voltage applied is preferably not less than 18 V, and more preferably not less than 20 V. Current density applied is preferably from to 30 A/dm². Quantity of electricity is preferably from 100 to 500 C/dm².

Thickness of the formed sulfuric acid anodization layer is preferably from 0.5 to 1.0 μm, and thickness of the formed phosphoric acid anodization layer is preferably from 0.1 to 0.5 μm. The coated amount of the formed anodization layer can be obtained from the weight difference between the aluminum plates before and after dissolution of the anodization layer. The anodization layer of the aluminum support is dissolved employing for example, an aqueous phosphoric acid chromic acid solution which is prepared by dissolving 35 ml of 85% by weight phosphoric acid and 20 g of chromium (IV) oxide in 1 liter of water.

Micro pores are formed in the anodization layer. The micro pore density in the anodization layer is preferably from 50 to 500/μm², and more preferably from 100 to 300/μm².

The phosphoric acid anodization layer has micro-pores having a pore size of from 40 to 100 nm, and the sulfuric acid anodization layer has micro-pores having a pore size of from 8 to 15 nm. Herein, the pore size of the micro-pores is defined as a diameter of a circle having the same area as that of the opening of the micro-pores, and is measured employing an electron micrograph of the micro-pores, taken at a 10000 magnification.

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

After the above treatments, the resulting aluminum plate is optionally subjected to hydrophilic treatment. The hydrophilic treatment method is not specifically limited. The support is suitably undercoated with a water soluble resin such as polyvinyl phosphonic acid, a polymer or copolymer having a sulfonic acid in the side chain, or polyacrylic acid; a water soluble metal salt such as zinc borate; a yellow dye, an amine salt; and so on. The sol-gel treatment support, which has a functional group capable of causing addition reaction by radicals as a covalent bond, is suitably used. It is preferred that the plate surface is subjected to hydrophilic treatment employing polyvinyl phosphoric acid. The hydrophilic treatment method is not specifically limited. There is for example, a coating method, a spraying method, or a dipping method. The dipping method is preferred in that the facility is cheap. The solution used in the dipping method is preferably an aqueous 0.05 to 3% polyvinyl phosphonic acid solution. The treating temperature is preferably from 20 to 90° C., and the treating time is preferably from 10 to 180 seconds. After the hydrophilic treatment, excessive polyvinyl phosphonic acid is removed from the support surface preferably through washing or squeegeeing. After that, it is preferred that the support is dried at preferably from 50 to 200° C.

(Image Formation Layer)

In the invention, an image formation layer, particularly an image formation layer capable of forming an image by laser light exposure, is provided on the aluminum support for a planographic printing plate of the invention. The image formation layer is not specifically limited, and may be a so-called processless type image formation layer capable of being developed on a printing press or those requiring development treatment such as a positive-working or negative working image formation layer or a photopolymerizable image formation layer.

The thickness of the image formation layer is preferably from 0.5 to 5 g/m², and more preferably from 0.8 to 3 g/m².

A planographic printing plate material of photopolymer type (a photopolymerizable light sensitive planographic printing plate material) is preferably used, which comprises a photopolymerizable light sensitive layer as a negative working image formation layer, and will be explained in detail below.

(Photopolymerization Initiator)

A photopolymerization initiator used in the photopolymerizable light sensitive layer of the photopolymerizable light sensitive planographic printing plate material is preferably a titanocene compound, a triarylmonoalkylborate ammonium salt or an iron-arene complex.

As the titanocene compounds, there are compounds disclosed in Japanese Patent O.P.I. Publication Nos. 63-41483 and 2-291. Preferred examples thereof include bis(cyclopentadienyl)-Ti-dichloride, bis(cyclopentadienyl)-Ti-bisphenyl, bis(cyclopentadienyl)-Ti-bis-2,3,4,5,6-pentafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,4-difluorophenyl (IRUGACURE 727L, produced by Ciba Specialty Co., Ltd.), bis(cyclopentadienyl)-bis(2,6-difluoro-3-(pyry-1-yl)phenyl) titanium (IRUGACURE 784, produced by Ciba Specialty Co., Ltd.), bis(cyclopentadienyl)-bis(2,4,6-trifluoro-3-(pyry-1-yl)phenyl) titanium, and bis(cyclopentadienyl)-bis(2,4,6-trifluoro-3-(2,5-dimethylpyry-1-yl)phenyl) titanium. As the monoalkyltriaryl borate compounds, there are those described in Japanese Patent O.P.I. Publication Nos. 62-150242 and 62-143044. Preferred examples of the monoalkyl-triaryl borate compounds include tetra-n-butyl ammonium n-butyl-trinaphthalene-1-yl-borate, tetra-n-butyl ammonium n-butyl-triphenyl-borate, tetra-n-butyl ammonium n-butyl-tri-(4-tert-butylphenyl)-borate, tetra-n-butyl ammonium n-hexyl-tri-(3-chloro-4-methylphenyl)-borate, and tetra-n-butyl ammonium n-hexyl-tri-(3-fluorophenyl)-borate.

As the iron arene complexes, there are those described in Japanese Patent O.P.I. Publication No. 59-219307. Preferred examples of the iron arene complex include η-benzene-(η-cyclopentadienyl)iron.hexafluorophosphate, η-cumene)-(η-cyclopentadienyl)iron.hexafluorophosphate, η-fluoroene-(η-cyclopentadienyl)iron.hexafluorophosphate, η-naphthalene-(η-cyclopentadienyl)iron.hexafluorophosphate, η-xylene-(η-cyclopentadienyl)iron.hexafluorophosphate, and η-benzene-(ηcyclopentadienyl)iron.hexafluoroborate.

Another photopolymerization initiator can be used in combination. Examples thereof include carbonyl compounds, organic sulfur compounds, peroxides, redox compounds, azo or diazo compounds, halides and photo-reducing dyes disclosed in J. Kosar, “Light Sensitive Systems”, Paragraph 5, and those disclosed in British Patent No. 1,459,563.

Typical examples of the photopolymerization initiator used in combination include the following compounds:

A benzoin derivative such as benzoin methyl ether, benzoin i-propyl ether, or α,α-dimethoxy-α-phenylacetophenone; a benzophenone derivative such as benzophenone, 2,4-dichlorobenzophenone, o-benzoyl methyl benzoate, or 4,4′-bis (dimethylamino) benzophenone; a thioxanthone derivative such as 2-chlorothioxanthone, 2-i-propylthioxanthone; an anthraquinone derivative such as 2-chloroanthraquinone or 2-methylanthraquinone; an acridone derivative such as N-methylacridone or N-butylacridone; α,α-diethoxyacetophenone; benzil; fluorenone; xanthone; an uranyl compound; a triazine derivative disclosed in Japanese Patent Publication Nos. 59-1281 and 61-9621 and Japanese Patent O.P.I. Publication No. 60-60104; an organic peroxide compound disclosed in Japanese Patent O.P.I. Publication Nos. 59-1504 and 61-243807; a diazonium compound in Japanese Patent Publication Nos. 43-23684, 44-6413, 47-1604 and U.S. Pat. No. 3,567,453; an organic azide compound disclosed in U.S. Pat. Nos. 2,848,328, 2,852,379 and 2,940,853; orthoquinonediazide compounds disclosed in Japanese Patent Publication Nos. 36-22062b, 37-13109, 38-18015 and 45-9610; various onium compounds disclosed in Japanese Patent Publication No. 55-39162, Japanese Patent O.P.I. Publication No. 59-14023 and “Macromolecules”, Volume 10, p. 1307 (1977); azo compounds disclosed in Japanese Patent Publication No. 59-142205; metal arene complexes disclosed in Japanese Patent O.P.I. Publication No. 1-54440, European Patent Nos. 109,851 and 126,712, and “Journal of Imaging Science”, Volume 30, p. 174 (1986); (oxo) sulfonium organoboron complexes disclosed in Japanese Patent O.P.I. Publication Nos. 5-213861 and 5-255347; titanocenes disclosed in Japanese Patent O.P.I. Publication Nos. 59-152396 and 61-151197; transition metal complexes containing a transition metal such as ruthenium disclosed in “Coordination Chemistry Review”, Volume 84, p. 85-277 (1988) and Japanese Patent O.P.I. Publication No. 2-182701; 2,4,5-triarylimidazol dimmer disclosed in Japanese Patent O.P.I. Publication No. 3-209477; carbon tetrabromide; organic halide compounds disclosed in Japanese Patent O.P.I. Publication No. 59-107344.

(Trihaloalkyl Compound)

When an addition polymerizable ethylenically unsaturated monomer containing a photo-oxidizable group is used in the photopolymerizable light sensitive layer of the planographic printing plate material, a known compound with a photolytic trihaloalkyl group is preferably used in combination for a free-radical generating photoinitiator. This type of the photoinitiator is preferably a compound containing chlorine or bromine as a halogen. The trihaloalkyl group is preferably a trihalomethyl group, and is bonded directly or through a conjugated chain to an aromatic hydrocarbon or heterocyclic ring. A compound having a triazine ring with two trihalomethyl groups is preferred, and compounds disclosed in EP-A-137,452, and DE-A-2,118,259 and 2,243,621 is especially preferred. These compounds have an absorption at near ultraviolet regions, for example, at wavelength regions from 350 to 400 nm. An initiator having little or no absorption at the spectral regions of the emitted light, for example, trihalomethyltriazine of mesomerism structure having a substituent or aliphatic group with a short conjugated system is suitably used. A compound having an absorption at far ultraviolet regions, for example, phenyl trihalomethyl sulfone (typically, phenyl tribromomethyl sulfone) or phenyl trihalomethyl ketone, is also suitably used.

(Sensitizing Dye)

The photopolymerizable light sensitive layer of the planographic printing plate material of the invention preferably contains a sensitizing dye having an absorption maximum in the wavelength of light emitted from the light source or in the vicinity of the wavelength.

Examples of the sensitizing dyes, which can induce sensitivity to the wavelengths of visible to near infrared regions, include cyanines, phthalocyanines, merocyanines, porphyrins, spiro compounds, ferrocenes, fluorenes, fulgides, imidazoles, perylenes, phenazines, phenothiazines, polyenes, azo compounds, diphenylmethanes, triphenylmethanes, polymethine acridines, cumarines, ketocumarines, quinacridones, indigos, styryl dyes, pyrylium dyes, pyrromethene dyes, pyrazolotriazole compounds, benzothiazole compounds, barbituric acid derivatives, thiobarbituric acid derivatives, ketoalcohol borate complexes, and compounds disclosed in European Patent No. 568,993, U.S. Pat. Nos. 4,508,811 and 5,227,227, and Japanese Patent O.P.I. Publication Nos. 2001-125255 and 11-271969.

Examples in which the above polymerization initiators are used in combination with the sensitizing dye are disclosed in Japanese Patent O.P.I. Publication Nos. 2001-125255 and 11-271969.

It is preferred that the photopolymerizable light sensitive layer contains a sensitizing dye in an amount providing a reflection density of from 0.1 to 2.0 at the printing plate material surface. The sensitizing dye content of the image formation layer greatly differs due to molar extinction coefficient of the sensitizing dye or crystallinity in the image formation layer of the sensitizing dye, and is ordinarily from 0.5 to 10% by weight.

The content of the photopolymerization initiator, the trihaloalkyl compound or the sensitizing dye in the image formation layer is preferably from 0.1 to 20% by weight, and more preferably from 3 to 12% by weight. The content of the photopolymerization initiator is from 30 to 55 parts by weight, that of the trihaloalkyl compound from 3 to 15 parts by weight, and that of the sensitizing dye from 40 to 67 parts by weight, each based on the 100 parts by weight of the total weight of the photopolymerization initiator, the trihaloalkyl compound and the sensitizing dye.

(Polymer Binder)

As the polymer binder used in the photopolymerizable light sensitive layer can be used a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These resins can be used as an admixture of two or more thereof. The polymer binder is preferably a polyurethane resin or an acryl polymer.

As the polyurethane resin, there is a polyurethane resin with a substituent having acidic hydrogen as disclosed in Japanese Patent O.P.I. Publication No. 2001-117219, for example, a polyurethane resin having as a main skeleton a reaction product of diisocyanate and diol having a carboxyl group. As an alkali soluble polyurethane resin having a polymerizable double bond as a side chain, there is, for example, a reaction product of diisocyanate and diol having at least one ethylenically unsaturated bond as disclosed in Japanese Patent O.P.I. Publication No. 2001-125257. The alkali soluble polyurethane resin is preferably one having as a side chain a polymerizable double bond.

The polymer binder used in the invention is preferably a vinyl copolymer obtained by copolymerization of an acryl monomer, and more preferably a copolymer containing (a) a carboxyl group-containing monomer unit and (b) an alkyl methacrylate or alkyl acrylate unit as the copolymerization component.

Examples of the carboxyl group-containing monomer include an α,β,-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl est-er such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The polymer binder in the invention can further contain, as another monomer unit, a monomer unit derived from the monomer described in the following items (1) through (14):

(1) A monomer having an aromatic hydroxy group, for example, o-, (p- or m-) hydroxystyrene, or o-, (p- or m-) hydroxyphenylacrylate;

(2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

(3) A monomer-having an aminosulfonyl group, for example, m- or p-aminosulfonylphenyl methacrylate, m- or p-aminosulfonylphenyl acrylate, N-(p-aminosulfonylphenyl) methacrylamide, or N-(p-aminosulfonylphenyl)acrylamide;

(4) A monomer having a sulfonamido group, for example, N-(p-toluenesulfonyl)acrylamide, or N-(p-toluenesulfonyl)-methacrylamide;

(5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

(6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

(7) A vinyl ether, for example, ethyl vinyl ether, 2-chloroethyl vinyl ether, propyl vinyl ether, butyl vinyl ether, octyl vinyl ether, or phenyl vinyl ether;

(8) A vinyl ester, for example, vinyl acetate, vinyl chroloacetate, vinyl butyrate, or vinyl benzoate;

(9) A styrene, for example, styrene, methylstyrene, or chloromethystyrene;

(10) A vinyl ketone, for example, methyl vinyl ketone, ethyl vinyl ketone, propyl vinyl ketone, or phenyl vinyl ketone;

(11) An olefin, for example, ethylene, propylene, isobutylene, butadiene, or isoprene;

(12) N-vinylpyrrolidone, N-vinylcarbazole, or N-vinylpyridine,

(13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

(14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer.

The above vinyl polymer can be manufactured according to a conventional solution polymerization, bulk polymerization or suspension polymerization. A polymerization initiator used is not specifically limited, but examples thereof include azo bis type radical generating agents, for example, 2,2′-azobisiso-butyronitrile (AIBN) or 2,2′-azobis(2-methylbutyronitrile. The amount used of the polymerization initiator is ordinarily from 0.05 to 10.0 part by weight (preferably from 0.1 to 5 part by weight), based on 100 parts by weight of monomer used to prepare a (co)polymer. As the solvents used in the solution polymerization, there are organic solvents including ketones, esters or aromatics, for example, good solvents generally used in the solution polymerization such as toluene, ethyl acetate, benzene, methylcellosolve, ethylcellosolve, acetone, and methyl ethyl ketone. Among these, ones having a boiling point of from 60 to 120° C. are preferred. The solution polymerization is ordinarily carried out at 40 to 120° C. (preferably 60 to 110° C.), for 3 to 10 hours (preferably 5 to 8 hours) employing the above solvents. After completion of polymerization, the solvents are removed from the resulting polymerization solution to obtain a (co)polymer. Alternatively, the polymerization solution is used without removing the solvents in a double bond incorporation reaction as described later which follows.

The molecular weight of the polymer can be adjusted by selecting solvents used or by controlling polymerization temperature. The solvents used or the polymerization temperature for obtaining a polymer with an intended molecular weight is appropriately determined by monomers used. The molecular weight of the polymer can be also adjusted by mixing the above solvents with a specific solvent. Examples of the specific solvent include mercaptans such as n-octylmercaptan, n-dodecylmercaptan, t-dodecylmercaptan and mercaptoethanol, and carbon chlorides such as carbon tetrachloride, butyl chloride and propylene chloride. The mixing ratio of the specific solvent to the solvents described above can be properly determined by monomers used, solvents used or polymerization conditions.

The polymer binder is preferably a vinyl polymer having in the side chain a carboxyl group and a polymerizable double bond. As the polymer binder is also preferred an unsaturated bond-containing copolymer which is obtained by reacting a carboxyl group contained in the above vinyl copolymer molecule with for example, a compound having a (meth)acryloyl group and an epoxy group. Examples of the compound having a (meth)acryloyl group and an epoxy group in the molecule include glycidyl acrylate, glycidyl methacrylate and an epoxy group-containing unsaturated compound disclosed in Japanese Patent O.P.I. Publication No. 11-27196. Further, an unsaturated bond-containing copolymer which is obtained by reacting a hydroxyl group contained in the above vinyl copolymer molecule with for example, a compound having a (meth)acryloyl group and an isocyanate group. Examples of the compound having a (meth)acryloyl group and an isocyanate group in the molecule include vinyl isocyanate, (meth)acryl isocyanate, 2-(meth)acroyloxyethyl isocyanate, m- or p-isopropenyl-α, α′-dimethylbenzyl isocyanate, and (meth)acryl isocyanate, or 2-(meth)acroyloxyethyl isocyanate is preferred.

Reaction of a carboxyl group existing in the molecule of the vinyl copolymer with a compound having in the molecule a (meth)acryloyl group and an epoxy group can be carried out according to a well-known method. For example, the reaction is carried out at a temperature of 20 to 100° C., and preferably 40 to 80° C., and more preferably at a boiling point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an aliphatic epoxy group-containing unsaturated compound is incorporated into the vinyl copolymer. The reaction can be carried out in the presence of a catalyst or a polymerization inhibitor. As the catalyst, there are amines or ammonium chlorides. Examples of the amines include triethylamine, tributylamine, dimethylaminoethanol, diethylaminoethanol, methylamine, ethylamine, n-propylamine, i-propylamine, 3-methoxypropylamine, butylamine, allylamine, hexylamine, 2-ethylhexylamine, and benzylamine. Examples of the ammonium chlorides include triethylbenzylammonium chloride. The amount used of the catalyst is ordinarily from 0.01 to 20.0% by weight based on the weight of an aliphatic epoxy group-containing unsaturated compound used. Examples of the polymerization inhibitor include hydroquinone, hydroquinone monometyl ether, t-butylhydroquinone, 2,5-di-t-butylhydroquinone, methylhydroquinone, p-benzoquinone, methyl-p-benzoquinone, t-butyl-p-benzoquinone, and 2,5-diphenyl-p-benzoquinone. The amount used of the polymerization inhibitor is ordinarily from 0.01 to 5.0% by weight based on the weight of an aliphatic epoxy group-containing unsaturated compound used. The reaction process is controlled by measurement of an acid value of the reaction mixture and the reaction is terminated at the time when the acid value is zero.

Reaction of a hydroxyl group existing in the molecule of the vinyl copolymer with a compound having in the molecule a (meth)acryloyl group and an isocyanate group can be carried out according to a known method. For example, the reaction is carried out at a temperature of 20 to 100° C., and preferably 40 to 80° C., and more preferably at a boiling -point of solvent used (while refluxing), for 2 to 10 hours and preferably 3 to 6 hours. As the solvent used in the reaction, there are solvents used in the polymerization to obtain the vinyl copolymer above. After polymerization, the solvent in the polymerization can be used without being removed from the polymerization solution as a reaction solvent used for reaction in which an isocyanate group-containing unsaturated compound is incorporated into the vinyl copolymer. The reaction can be carried out in the presence of a catalyst or a polymerization inhibitor. As the catalyst, tin compounds or amines are preferably used. Examples of thereof include dibutyltin laurate, and triethylamine. The amount used of the catalyst is preferably from 0.01 to 20.0% by weight based on the weight of a double bond-containing compound used. Examples of the polymerization inhibitor include hydroquinone, hydroquinone monometyl ether, t-butylhydroquinone, 2,5-di-t-butylhydroquinone, methylhydroquinone, p-benzoquinone, methyl-p-benzoquinone, t-butyl-p-benzoquinone, and 2,5-diphenyl-p-benzoquinone. The amount used of the polymerization inhibitor is ordinarily from 0.01 to 5.0% by weight based on the weight of an aliphatic epoxy group-containing unsaturated compound used. The reaction process is controlled by measurement of infrared absorption spectra (IR) of the reaction mixture and the reaction is terminated at the time when the isocyanate absorption disappears.

The content of the vinyl polymer having in the side chain a carboxyl group and a polymerizable double bond is preferably from 50 to 100% by weight, and more preferably 100% by weight, based on the total weight of the polymer binder used.

The polymer binder content of the photopolymerizable light sensitive layer is preferably from 10 to 90% by weight, more preferably from 15 to 70% by weight, and still more preferably from 20 to 50% by weight, in view of sensitivity.

(Addition Polymerizable Ethylenically Unsaturated Monomer Containing a Photo-Oxidizable Group)

The addition polymerizable ethylenically unsaturated monomer used in the photopolymerizable light sensitive layer in the invention is preferably an addition polymerizable ethylenically unsaturated monomer containing a photo-oxidizable group. An addition polymerizable ethylenically unsaturated monomer containing both photo-oxidizable group and urethane group is especially preferred. Examples of the photo-oxidizable group include a thio group, thioether group, a ureido group, an amino group, and an enol group, each of which may be a member constituting heterocycles. As moieties containing these groups, there are, for example, a triethanolamine moiety, a triphenylamine moiety, a thioureide moiety an imidazole moiety, an oxazole moiety, a thiazole moiety, an acetylacetone moiety, an N-phenylglycine moiety, and an ascorbic acid moiety. Preferred is an addition polymerizable monomer containing a tertiary amino group or a thioether group.

Exemplified compounds containing a photo-oxidizable group are listed in European Patent Publication Nos. 287,818, 353,389 and 364,735. Among the exemplified compounds, compounds containing a tertiary amino group, and a ureido group and/or a urethane group are preferred. Examples of the addition polymerizable ethylenically unsaturated monomer containing both photo-oxidizable group and a urethane group are listed in Japanese Patent Publication No. 2669849, and Japanese Patent O.P.I. Publication Nos. 63-260909, 6-35189, and 2001-125255.

In the invention, a reaction product of a tertiary amine having two or more hydroxyl groups in the molecule, a diisocyanate and a compound having a hydroxyl group and an addition polymerizable ethylenically double bond in the molecule is preferably used.

The tertiary amine having two or more hydroxyl groups in the molecule has a hydroxyl group of preferably from 2 to 6, and more preferably from 2 to 4. Examples of the tertiary amine having two or more hydroxyl groups in the molecule include triethanolamine, N-methyldiethanolamine, N-ethyldiethanolamine, N-ethyldiethanolamine, N-n-butyldiethanolamine, N-tert-butyldiethanolamine, N,N-di(hydroxyethyl)aniline, N,N, N′, N′-tetra-2-hydroxypropylethylenediamine, p-tolyldiethanolamine, N,N, N′, N′-tetra-2-hydroxyethylethylenediamine, N,N-bis(2-hydroxypropyl)aniline, allyldiethanolamine, 3-dimethylamino-1,2-propane diol, 3-diethylamino-1,2-propane diol, N,N-di(n-propylamino)-2,3-propane diol, N,N-di(iso-propylamino)-2,3-propane diol, and 3-(N-methyl-N-benzylamino)-1,2-propane diol, but the invention is not specifically limited thereto.

Examples of the diisocyanate include butane-1,4-diisocyanate, hexane-1,6-diisocyanate, 2-methylpentane-1,5-diisocyanate, octane-1,8-diisocyanate, 1,3-diisocyanatomethylcyclohexanone, 2,2,4-trimethylhexane-1,6-diisocyanate, isophorone diisocyanate, 1,2-phenylene diisocyanate, 1,3-phenylene diisocyanate, 1,4-phenylene diisocyanate, tolylene-2,4-diisocyanate, tolylene-2,5-diisocyanate, tolylene-2,6-diisocyanate, 1,3-di(isocyanatomethyl)benzene, and 1,3-bis(1-isocyanato-1-methylethyl)benzene, but the invention is not specifically limited thereto. Examples of the compound having a hydroxyl group and an addition polymerizable ethylenically double bond in the molecule is not specifically limited, but 2-hydroxyethyl methacrylate, 2-hydroxyethyl acrylate, 4-hydroxybutyl acrylate, 2-hydroxypropylene-1,3-dimethacrylate, and 2-hydroxypropylene-l-methacrylate-3-acrylate are preferred.

The reaction product can be synthesized according to the same method as a conventional method in which a urethaneacrylate compound is ordinarily synthesized employing a diol, a diisocyanate and an acrylate having a hydroxyl group.

Examples of the reaction product of a tertiary amine having two or more hydroxyl groups in the molecule, a diisocyanate having an aromatic ring in the molecule and a compound having a hydroxyl group and an addition polymerizable ethylenically double bond in the molecule will be listed below.

M-1: A reaction product of triethanolamine (1 mole), hexane-1,6-diisocyanate (3 moles), and 2-hydroxyethyl methacrylate (3 moles)

M-2: A reaction product of triethanolamine (1 mole), isophorone diisocyanate (3 moles), and 2-hydroxyethyl methacrylate (3 moles)

M-3: A reaction product of N-n-butyldiethanolamine (1 mole), 1,3-bis(1-cyanato-1-methylethyl)benzene (2 moles), and 2-hydroxypropylene-1-methacrylate-3-acrylate (2 moles)

M-4: A reaction product of N-n-butyldiethanolamine (1 mole), 1,3-di(cyanatomethyl)benzene (2 moles), and 2-hydroxypropylene-1-methacrylate-3-acrylate (2 moles)

M-5: A reaction product of N-methydiethanolamine (1 mole), tolylene-2,4-diisocyanate (2 moles), and 2-hydroxypropylene-1,3-dimethacrylate (2 moles)

In addition to the above, acrylates or methacrylates disclosed in Japanese Patent O.P.I. Publication Nos. 2-105238 and 1-127404 can be used.

(Other Addition Polymerizable Ethylenically Unsaturated Monomer)

In the invention, another addition polymerizable ethylenically unsaturated monomer can be used with the monomers described above. As another addition polymerizable ethylenically unsaturated monomer, there are conventional radical polymerizable monomers, polyfunctional monomers having plural ethylenically unsaturated bond, and polyfunctional oligomers. Examples thereof include an acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryl-oxyethyl acrylate, tetrahydrofurfuryloxyhexanorideacrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrrogallol triacrylate, propionic acid dipentaerythritol triacrylate, propionic acid dipentaerythritol tetraacrylate or hydroxypivalylaldehyde modified dimethylolpropane triacrylate or EO-modified products thereof; and a methacrylate, itaconate, crotonate or maleate alternative of the above polyfunctional acrylate.

A prepolymer can be used, and examples of the prepolymer include compounds as described later. The prepolymer with a photopolymerizable property, which is obtained by incorporating acrylic acid or methacrylic in an oligomer with an appropriate molecular weight, can be suitably employed. This prepolymer can be used singly, as an admixture of the above described monomers and/or oligomers.

Examples of the prepolymer include polyester (meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A-epichlorhydrin-(meth)acrylic acid or phenol novolak-epichlorhydrin-(meth)acrylic acid obtained by incorporating (meth)acrylic acid in an epoxy resin; an urethaneacrylate such as ethylene glycol-adipic acid.tolylenediisocyanate 2-hydroxyethylacrylate, polyethylene glycol.tolylenediisocyanate.2-hydroxyethylacrylate, hydroxyethylphthalyl methacrylate.xylenediisocyanate, 1,2-polybutadieneglycol.tolylenediisocyanate.2-hydroxyethylacrylate or trimethylolpropane-propylene glycol.tolylenediisocyanate.2-hydroxyethylacrylate, obtained by incorporating (meth)acrylic acid in an urethane resin; a silicone acrylate such as polysiloxane acrylate, or polysiloxane.diisocyanate.2-hydroxyethylacrylate; an alkyd modified acrylate obtained by incorporating a methacroyl group in an oil modified alkyd resin; and a spiran resin acrylate.

The photopolymerizable light sensitive layer of the planographic printing plate material of the invention can contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer. As a monomer used in the photopolymerizable light sensitive layer, there is a phosphate compound having at least one (meth)acryloyl group. The phosphate compound is a compound having a (meth)acryloyl group in which at least one hydroxyl group of phosphoric acid is esterified, and the phosphate compound is not limited as long as it has a (meth)acryloyl group.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV.EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

The content of the ethylenically unsaturated monomers described above in the photopolymerizable light sensitive layer is preferably from 1.0 to 80.0% by weight, and more preferably from 3.0 to 70.0% by weight.

(Compound having a Cationically Polymerizable Group)

The photopolymerizable light sensitive layer of the planographic printing plate material of the invention can further contain a compound having a cationically polymerizable group. Examples of the cationically polymerizable group, there are a group having a cyclic ether structure such as an oxirane ring, an oxetane ring or a dioxolane ring; and a group having an unsaturated ether structure such as vinyl ether or allyl ether. A compound having a cationically polymerizable group such as such as an oxirane ring, an oxetane ring or a dioxolane ring and a radically polymerizable group is especially preferred.

(Additives)

In the invention, the photopolymerizable light sensitive layer may contain a hindered phenol compound, a hindered amine compound or other polymerization inhibitors in addition to the compounds described above, in order to prevent undesired polymerization of the ethylenically unsaturated monomer during the manufacture or storage of the planographic printing plate material.

Examples of the hindered phenol compound include 2,6-di-t-butyl-p-cresol, butylhydroxyanisole, 2,2′-methylenebis(4-methyl-6-t-butylphenol), 4,4′-butylidenebis(3-methyl-6-t-butylphenol), tetrakis[methylene-3-(3′,5′-t-butyl-4′-hydroxyphenyl)- propionate]methane, bis[3,3′-bis(4′-hydroxy-3′-t-butylphenyl) butyric acid]glycol ester, 2-t-butyl-6-(3-t-butyl-2-hydroy-5-methylbenzyl)-4-methylphenyl acrylate, and 2-[1-(2-hydroxy-3,5-di-t-pentylphenyl)ethyl]-4,6-di-t-pentylphenyl acrylate. Among them, 2-t-butyl-6-(3-t-butyl-2-hydroy-5-methylbenzyl)- 4-methylphenyl acrylate and 2-[1-(2-hydroxy-3,5-di-t-pentylphenyl)ethyl]-4,6-di-t-pentylphenyl acrylate, each having a (meth)acryloyl group, are preferred.

Examples of the hindered amine compound include bis(1,2,2,6,6-pentamethyl-4-piperidyl)sebacate, bis(2,2,6,6-tetramethyl-4-piperidyl)sebacate, 1-[2-{3-(3,5-di-t-butyl-hydroxyphenyl)propionyloxy}ethyl]-4-[2-{3-(3,5-di-t-butyl-hydroxyphenyl)propionyloxy}ethyl]-2,2,6,6-tetramethylpiperidine, 4-benzoyloxy-2,2,6,6-tetramethylpiperidine, and 8-acetyl-3-dodecyl-7,7,9,9-tetramethyl-1,3,8-triazaspiro-[4.5]decane-2,4-dione.

Examples of another polymerization inhibitor include hydroquinone, p-methoxyphenol, di-t-butyl-p-cresol, pyrrogallol, t-butylcatechol, benzoquinone, 4,4′-thiobis (3-methyl-6-t-butylphenol), 2,2′-methylenebis (4-methyl-6-t-butylphenol), N-nitrosophenylhydroxylamine cerous salt, and hindered amines such as 2,2,6,6-tetramethylpiperidine derivatives -butyl-6-(3-t-butyl-6-hydroxy-5-mrthylbenzyl)-4-methylphenyl acrylate.

The polymerization inhibitor content is preferably 0.01 to 5% by weight based on the total solid content of photopolymerizable light sensitive layer. Further, in order to prevent polymerization induced by oxygen, a higher fatty acid such as behenic acid or a higher fatty acid derivative such as behenic amide may be added to the photopolymerizable light sensitive layer, or may be localized on the surface of the photopolymerizable light sensitive layer in the course of drying after coating. The higher fatty acid or higher fatty acid derivative content is preferably 0.5 to 10% by weight based on the total solid content of the photopolymerizable light sensitive layer.

The photopolymerizable light sensitive layer can contain a colorant. As the colorant can be used known materials including commercially available materials. Examples of the colorant include those described in revised edition “Ganryo Binran”, edited by Nippon Ganryo Gijutu Kyoukai (publishe by Seibunndou Sinkosha), or “Color Index Binran”.

Kinds of the pigment include black pigment, yellow pigment, red pigment, brown pigment, violet pigment, blue pigment, green pigment, fluorescent pigment, and metal powder pigment. Examples of the pigment include inorganic pigment (such as titanium dioxide, carbon black, graphite, zinc oxide, Prussian blue, cadmium sulfide, iron oxide, or chromate of lead, zinc, barium or calcium); and organic pigment (such as azo pigment, thioindigo pigment, anthraquinone pigment, anthanthrone pigment, triphenedioxazine pigment, vat dye pigment, phthalocyanine pigment or its derivative, or quinacridone pigment).

Among these pigment, pigment is preferably used which does not substantially have absorption in the absorption wavelength regions of a spectral sensitizing dye used according to a laser for exposure. The absorption of the pigment used is not more than 0.05, obtained from the reflection spectrum of the pigment measured employing an integrating sphere and employing light with the wavelength of the laser used. The pigment content of the photopolymerizable light sensitive layer is preferably 0.1 to 10% by weight, and more preferably 0.2 to 5% by weight, based on the total solid content of photopolymerizable light sensitive layer.

The photopolymerizable light sensitive layer may contain a plasticizer in order to increase it adhesion to the support. Examples of the plasticizer include dimethyl phthalate, diethyl phthalate, dibutyl phthalate, diheptyl phthalate, di-2-ethylhexyl phthalate, di-n-octyl phthalate, didodecyl phthalate, diisodecyl phthalate, butylbenzyl phthalate, diisononyl phthalate, didodecyl phthalate, ethylphthalyl ethyl glycol, dimethyl isophthalate, triethylene glycol dicaprylate, dimethyl glycol phthalate, tricresyl phosphate, dioctyl adipate, dibutyl sebacate, and triacetyl glycerin. The plasticizer content of the photopolymerizable light sensitive layer is preferably not more than 3% by weight, and more preferably from 0.1 to 2% by weight, based on the total solid content of photopolymerizable light sensitive layer.

The photopolymerizable light sensitive layer can contain a surfactant as a coatability improving agent, as long as performance of the invention is not jeopardized. The surfactant is preferably a fluorine-contained surfactant.

The photopolymerizable light sensitive layer can contain inorganic fillers or a plasticizer such as dioctyl phthalate, dimethyl phthalate or tricresyl phosphate for improving a physical property of the photopolymerizable light sensitive layer. The content of the surfactant, filler or plasticizer of the photopolymerizable light sensitive layer is preferably not more than 10% by weight.

(Coating)

The solvents used in the preparation of a coating liquid for the photopolymerizable image formation layer in the invention include an alcohol such as sec-butanol, isobutanol, n-hexanol, or benzyl alcohol; a polyhydric alcohol such as diethylene glycol, triethylene glycol, tetraethylene glycol, or 1,5-pentanediol; an ether such as propylene glycol monobutyl ether, dipropylene glycol monomethyl ether, or tripropylene glycol monomethyl ether; a ketone or aldehyde such as diacetone alcohol, cyclohexanone, or methyl cyclohexanone; and an ester such as ethyl lactate, butyl lactate, diethyl oxalate, or methyl benzoate.

The coating liquid for the photopolymerizable light sensitive layer is coated on a support according to a conventional method, and dried to obtain a planographic printing plate material. Examples of the coating method include an air doctor coating method, a blade coating method, a wire bar coating method, a knife coating method, a dip coating method, a reverse roll coating method, a gravure coating method, a cast coating method, a curtain coating method, and an extrusion coating method.

The drying temperature of a coated photopolymerizable light sensitive layer is preferably from 60 to 160° C., more preferably from 80 to 140° C., and still more preferably from 90 to 120° C.

(Protective Layer)

A protective layer is preferably provided on the photopolymerizable light sensitive layer of the planographic printing plate material of the invention. It is preferred that the protective layer (oxygen shielding layer) is highly soluble in a developer (generally an alkaline solution) described later.

Materials constituting the protective layer are preferably polyvinyl alcohol, polysaccharide, polyvinyl pyrrolidone, polyethylene glycol, gelatin, glue, casein, hydroxyethyl cellulose, carboxymethyl cellulose, methyl cellulose, hydroxyethyl starch, gum arabic, sucrose octacetate, ammonium alginate, sodium alginate, polyvinyl amine, polyethylene oxide, polystyrene sulfonic acid, polyacrylic acid, or a water soluble polyamide. These materials may be used alone or in combination. Especially preferred material is polyvinyl alcohol.

A coating liquid for the protective layer is obtained by dissolving the materials described above in a solvent. The coating liquid is coated on the photopolymerizable light sensitive layer and dried to form a protective layer. The dry thickness of the protective layer is preferably from 0.1 to 5.0 μm, and more preferably from 0.5 to 3.0 μm. The protective layer may contain a surfactant or a matting agent.

The same coating method as described above in the photopolymerizable light sensitive layer applies in the protective layer coating method. The drying temperature of the protective layer is preferably lower than that of the photopolymerizable light sensitive layer. The former is preferably not less than 10° C. lower than that of the latter, and more preferably not less than 20° C. lower than that of the latter. Further, the drying temperature of the protective layer is preferably lower than a glass transition temperature (Tg) of the binder contained in the light sensitive layer. The drying temperature of the protective layer is preferably not less than 20° C. lower than Tg of the binder contained in the photopolymerizable light sensitive layer, and more preferably not less than 40° C. lower than Tg of the binder contained in the photopolymerizable light sensitive layer. The drying temperature of the protective layer is preferably at most 60° C. lower than Tg of the binder contained in the photopolymerizable light sensitive layer.

(Image Formation Method)

The planographic printing plate material of the invention is imagewise exposed employing laser sources. The laser sources, for example, emitting a 350 to 450 nm laser available, are as follows.

A gas laser such as an Ar ion laser (364 nm and 351 nm), a Kr ion laser (356 nm, 351nm), a He—Cd laser (441 nm), a solid laser such as a laser employing two of a combination of ND:YAG (YVO4) and SHG crystal (355 nm), or a laser employing a combination of Cr:LiSAF and SHG crystal (430 nm), a semiconductor laser such as KnbO₃, ring resonator (430 nm), a combination of a guiding wavelength conversion element, and AlGaAs, InGaAs semiconductor (300 to 450 nm), a combination of a guiding wavelength conversion element, and AlGaInP, InGaAs semiconductor (300 to 350 nm), AlGaInN (350 to 450 nm), and a pulse laser such as an N₂ laser (337 nm, pulse: 0.1 to 10 mJ) or an XeF laser (351 nm, pulse: 10 to 250 mJ). The especially preferred one is an AlGaInN semiconductor laser (an InGaN type semiconductor laser available on the market, 400 to 410 nm), which is suitable in view of wavelength characteristics and cost performance. As a light source available emitting a 450 to 700 nm light, an Ar⁺ laser (488 nm), a YAG-SHG laser (532 nm), an He-Ne laser (633 nm), or an Hd-Cd laser, or a red semiconductor laser (650 to 690 nm) can be used, and as a light source available emitting a 700 to 1200 nm light, a semiconductor laser (800 to 850 nm) or an Nd-YAG laser (1064 nm) can be used. Besides the above can be used a super high pressure, high pressure, intermediate pressure or low pressure mercury lamp, a chemical lamp, a carbon arc lamp, a xenon lamp, a metal halide lamp, an an ultraviolet laser lamp (an ArF excimer laser or a KrF excimer laser), and radiations such as electron beam, X-rays, ion beam or far infrared rays. The preferred are lasers emitting light with a.wavelength of not less than 350 nm in view of cost performance.

A laser scanning method by means of a laser beam includes a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an FO lens, and sub-scanning is carried out by moving a recording medium. The method of scanning on an outer surface of a cylinder, and the method of scanning on an inner surface of a cylinder are preferred in optical system accuracy and high density recording.

(Heating Treatment)

In the invention, heating treatment is preferably carried out after imagewise exposure, which increases the image formation speed and sensitivity and improves printing durability. The heating treatment method is not specifically limited, and non-contact heating, in which a heating means does not contact the image formation layer surface, is preferred. As the heating means, a conventional thermostat, a hot-air drying device, and an automatic developing machine available on the market installed with a heater can be used. The heating temperature is preferably from 100 to 130° C., in view of fog prevention, sensitivity, or printing durability. The heating time is preferably from 5 to 60 seconds, in view of fog prevention, sensitivity, or printing durability. Further, time taken from completion of imagewise exposure till when heating treating is carried out is preferably not more than 300 seconds.

(Development)

In the invention, a developer or developer replenisher used in the development preferably contains at least one compound selected from silicic acid, phosphoric acid, carbonic acid, phenols, saccharides, and fluorinated alcohols. The pH thereof is preferably from more than 8.5 to less than 13.0, and more preferably from 8.5 to 12. Of the above compounds, weak acid compounds such as phenols, saccharides, oximes, and fluorinated alcohols have an acid dissociation constant (pKa) of preferably from 10.0 to 13.2. Such acid compounds are selected from those described in “IONIZATION CONSTANTS OF ORGANIC ACIDS IN AQUEOUS SOLUTION” published by Pergamon Press Co. Ltd. Examples thereof include phenols having a phenolic hydroxyl group such as salicylic acid (pKa: 13.0), 3-hydroxy-2-naphthoic acid (pKa: 12.84), catechol (pKa: 12.6), gallic acid (pKa: 12.4), sulfosalicylic acid (pKa: 11.7), 3,4-dihydroxysulfosalicylic acid (pKa: 12.2), 3,4-dihydroxybenzoic acid (pKa: 11.94), 1,2,4-trihydroxybenzene (pKa: 11.82), hydroquinone (pKa: 11.56), pyrogallol (pKa: 11.34), o-cresol (pKa: 10.33), resorcinol (pKa: 11.27), p-cresol (pKa: 10.27), and m-cresol (pKa: 10.09).

As the saccharides, non-reducing saccharides, which are stable in an alkali solution, are preferably used. The non-reducing saccharides are those which do not have a free aldehyde group or ketone group, and therefore do not have reducibility. They are classified into trehalose type oligosaccharides in which monosaccharides combine with each other through the reducing groups, glycosides in which saccharides combine with another compound through their reducing group, and sugar alcohols obtained by reducing saccharides, each of which can be suitably used in the invention. Examples of the trehalose type oligosaccharide include trehalose and saccharose. Examples of the glycosides include alkyl glycosides, phenol glycosides, and mustard oil glycoside. Examples of the sugar alcohols include D,L-arabitol, ribitol, xylitol, D,L-sorbitol, D,L-mannitol, D,L-iditol, D,L-talitol, D,L-dulcitol, and D,L-allodulcitol. Maltitol obtained by hydrogenation of disaccharides or reduced oligosaccharides (reduced starch syrup) obtained by hydrogenation of oligosaccharides are suitably used.

Examples of the oximes include 2-butanoneoxime (pKa: 12.45), acetoxime (pKa: 12.42), 1,2-cycloheptanedioxime (pKa: 12.3), 2-hydroxybenzaldehideoxime (pKa: 12.10), dimethylglyoxime (pKa: 12.9), ethanediamidedioxime (pKa: 11.37), acetophenoneoxime (pKa: 11.35). Examples of the fluorinated alcohols include 2,2,3,3-tetrafluoropropanol-1 (pKa: 12.74), trifluoroethanol (pKa: 12.37), and trichloroethanol (pKa: 12.24). Further, aldehydes, nucleic acid related substances or other weak acids are used. Examples of the aldehydes include pyridine-2-aldehyde (pKa: 12.68) and pyridine-4-aldehyde (pKa: 12.05). Examples of the nucleic acid related substances include adenosine (pKa: 12.56), inosine (pKa: 12.5), guanine (pKa: 12.3), cytosine (pKa: 12.2), hypoxanthine (pKa: 12.1), and xanthine (pKa: 11.9). Examples of the other weak acids include diethylaminomethylsulfonic acid (pKa: 12.32), 1-amino-3,3,3-trifluorobenzoic acid (pKa: 12.29), isopropylidenedisulfonic acid (pKa: 12.10), 1,1-ethylidenediphosphonic acid (pKa: 11.54), 1,1-diethylidenedisulfonic acid-l-hydroxy (pKa: 11.52), benzimidazole (pKa: 12.86), thiobenzamide (pKa: 12.8), picolinthioamide (pKa: 12.55), and barbituric acid (pKa: 12.5). These acid compounds can be used singly or as a mixture of two or more thereof. Of these compounds, silicic acid, phosphoric acid, sulfosalicylic acid, salicylic acid, sugar alcohol, and saccharose are preferred, and silicic acid, D-sorbitol, saccharose, and reduced starch syrup are particularly preferred, since they are inexpensive and show buffering action in appropriate pH regions.

These acid compounds are contained in the developer or developer replenisher in an amount of preferably from 0.1 to 30% by weight, and more preferably from 1 to 20% by weight. When the content of the weak acid compound is less than 0.1%, it does not provide a sufficient buffering effect, while when the content of the weak acid compound is more than 30%, such a concentration is too high to obtain a developer or developer replenisher, resulting in cost increase. The alkali agents used in combination with the above acid compounds include sodium hydroxide, potassium hydroxide, ammonium hydroxide and lithium hydroxide. These alkali agents may be used singly or in combination of two or more kinds thereof. The image portions of a printing plate obtained by developing a light sensitive planographic printing plate material with a developer with a pH of not more than 8.5 show low mechanical strength and is low in mechanical strength, and is likely to be abraded during printing, resulting in lowering of printing durability. Further, the resulting image portions are chemically low, and are low in resistance to chemicals such as ink cleaning agent or a plate cleaner used in printing, resulting in poor chemical resistance. In contrast, a developer with a pH of from more than 13.0 shows strong skin irritation and must be carefully handled, and such a developer is undesired.

Other examples of the alkali agents in the invention include potassium silicate, sodium silicate, lithium silicate, ammonium silicate, potassium metasilicate, sodium metasilicate, lithium metasilicate, ammonium metasilicate, potassium phosphate, sodium phosphate, lithium phosphate, ammonium phosphate, potassium hydrogenphosphate, sodium hydrogenphosphate, lithium hydrogenphosphate, ammonium hydrogenphosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate, and ammonium borate. In order to adjust pH of the developer, sodium hydroxide, potassium hydroxide, ammonium hydroxide and lithium hydroxide can be used. Organic alkali agents, including monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine, are also used in combination with the above compounds. The preferred alkali agent is potassium silicate or sodium silicate. The concentration of silicate in the developer is preferably from 1.0 to 3.0% by weight in terms of SiO₂ concentration. The ratio by mole (SiO₂/M) of SiO₂ to alkali metal M is preferably from 0.25 to 2.

The developer in the invention refers to a developer (so-called working developer) replenished with developer replenisher in order to maintain activity of the developer which lowers during development of light sensitive planographic printing plate material, as well as fresh developer used at the beginning of development.. The developer replenisher is required to be higher in activity (for example, in alkali agent concentration) than the working developer, and may have a pH exceeding 13.0.

(Surfactant)

Various surfactants or organic solvents can be optionally added to a developer or a developer replenisher used in the invention, in order to accelerate development, disperse smuts occurring during development, or enhance ink receptivity at the image portions of a printing plate.

Preferred examples of the surfactant include an anionic surfactant, a cationic surfactant, a nonionic surfactant, and an amphoteric surfactant.

Preferred examples of the nonionic surfactant include polyoxyethylenealkyl ethers, polyoxyethylenealkylphenyl ethers, polyoxyethylene-polystyrylphenyl ethers, polyoxyethylenepolyoxypropylenalkyl ethers, partial esters of glycerin and fatty acids, partial esters of sorbitan and fatty acids, partial esters of pentaerythritol and fatty acids, propylene glycol monofatty acid ester, partial esters of sucrose and fatty acids, partial esters of polyoxyethylenesorbitan and fatty acids, partial esters of polyoxyethylenesorbitol and fatty acids, esters of polyoxyethylene glycol and fatty acids, partial esters of polyglycerin and fatty acids, polyoxyethylene castor oil, partial esters of polyoxyethyleneglycerin and fatty acids, polyoxyethylene-polyoxypropylene block copolymer, adduct of polyoxyethylene-polyoxypropylene block copolymer with ethylene imine, fatty acid diethanolamides, N,N-bis-2-hydroxyalkylamines, polyoxyethylenealkylamines, triethanolamine fatty acid esters, and trialkylamine oxides. Examples of the anionic surfactant include fatty acid salts, abietic acid salts, hydroxyalkane sulfonic acid salts, alkane sulfonic acid salts, dialkylsulfosuccinic acid salts, straight-chained alkylbenzene sulfonic acid salts, branched alkylbenzene sulfonic acid salts, alkylnaphthalene sulfonic acid salts, alkyldiphenylether sulfonic acid salts, alkylphenoxypolyoxyethylenepropyl sulfonic acid salts, polyoxyethylenealkyl sulfophenylether salts, N-methyl-N-oleiltaurine sodium salts, N-alkylsulfosuccinic acid monoamide disodium salts, petroleum sulfonic acid salts, nitrated castor oil, sulfated beef tallow, fatty acid alkyl ester sulfate salts, alkylsulfate salts, polyoxyethylenealkylethersulfate salts, fatty acid monoglyceride sulfate salts, polyoxyethylenealkylphenylethersulfate salts, polyoxyethylenestyrylphenylethersulfate salts, alkylphosphate salts, polyoxyethylenealkyletherphosphate salts, polyoxyethylenealkylphenyletherphosphate salts, partial saponification products of styrene-maleic anhydride copolymers, partial saponification products of olefin-maleic anhydride copolymers, and condensates of naphthalene sulfonic acid salts with formalin. Examples of the cationic surfactant include alkylamine salts, quaternary ammonium salts such as tetrabutylammonium bromide, polyoxyethylene alkylamine salts, and polyethylene polyamine derivatives. Examples of the amphoteric surfactant include carboxybetains, aminn carboxylic acids, sulfobetaines, aminosulfates and imidazolines.

The “polyoxyethylene” described above can be replaced with polyoxyalkylene such as polyoxymethylene, polyoxypropylene, or polyoxybutylene. A more preferred surfactant is a fluorine-containing surfactant having a perfluoroalkyl group in the molecule. Examples thereof include anionic surfactants such as perfluoroalkylcarboxilic acid salts, or perfluoroalkylsurfuric acid salts, amphoteric surfactants such as perfluorobetaines, cationic surfactants such as perfluoroalkyltrimethylammonimum chlorides, and nonionic surfactants such as perfluoroalkylamineoxides, perfluoroalkylethyleneoxide adducts, oligomers having a perfluoroalkyl group and a hydrophilic group, oligomers having a perfluoroalkyl group and an oleophilic group, oligomers having a perfluoroalkyl group, a hydrophilic group, and an oleophilic group, and urethanes having a perfluoroalkyl group and an oleophilic group. These surfactants can be used singly or as a mixture of two or more thereof. The developer preferably contains the surfactant in an amount of preferably from 0.001 to 10% by weight, and more preferably from 0.01 to 5% by weight.

(Development Stabilizing Agent)

The developer or developer replenisher used in the invention optionally contains a development stabilizing agent. The preferred examples of the development stabilizing agent include an adduct of sugar alcohol with polyethylene glycol, tetraalkylammonium hydroxide such as tetrabutylammonium hydroxide, a phosphonium salt such as tetrabutylphosphonium bromide, and an iodonium salt such as diphenyliodonium chloride, as disclosed in Japanese Patent O.P.I. Publication No. 6-282079.

Examples of the development stabilizing agent include anionic surfactants or amphoteric surfactants disclosed in Japanese Patent O.P.I. Publication No. 50-51324, water soluble cationic polymers disclosed in Japanese Patent O.P.I. Publication No. 55-95946, and water soluble amphoteric surfactants disclosed in Japanese Patent O.P.I. Publication No. 56-142528. Further, the examples include organic boron-containing compound to which alkylene glycol is added, disclosed in Japanese Patent O.P.I. Publication No.59-84241, polyoxyethylene-polyoxypropylene block polymer type water-soluble surfactant, disclosed in Japanese Patent O.P.I. Publication No.60-111264, an alkylenediamine compound having polyoxyethylene-polyoxypropylene, disclosed in Japanese Patent O.P.I. Publication No.60-129750, polyoxyethylene, glycol with an average weight molecular weight of not less than 300 disclosed in Japanese Patent O.P.I. Publication No.61-215554, a fluorine-containing surfactant having a cationic group disclosed in Japanese Patent O.P.I. Publication No.63-175858, and a water soluble ethyleneoxide adduct obtained by adding ethyleneoxy to an acid or an alcohol, or water soluble polyalkylenes disclosed in Japanese Patent O.P.I. Publication No. 2-39157.

(Organic Solvent)

Organic solvents are optionally added to a developer or a developer replenisher. The organic solvent is a solvent having a solubility in water of suitably 10 weight % or less, and preferably 5 weight % or less. Examples of the organic solvent include 1-phenylethanol, 2-phenylethanol, 3-phenyl-1-propanol, 4-phenyl-l-butanol, 1-phenyl-2-butanol, 2-phonoxyethanol, 2-benzyloxyethanol, o-methoxybenzylalcohol, m-methoxybenzylalcohol, p-methoxybenzylalcohol, benzylalcohol, cyclohexanol, 2-methylcyclohexanol, 3-methylcyclohexanol, 4-methylcyclohexanol, N-phenylethanolamine, and N-phenyldiethanolamine. The organic solvent content of the working developer is preferably 0.1 to 5 weight %. It is preferred that the organic solvent content is not substantially contained in the developer or developer replenisher. The term “not substantially contained” means that the organic solvent is contained in an amount of not more than 1% by weight.

(Reducing Agent)

A reducing agent is optionally added to the developer or developer replenisher used in the invention. This is added in order to prevent occurrence of stains on the printing plate during printing. The addition is particularly effective in developing a negative working light sensitive planographic printing plate material comprising a light sensitive diazonium compound. Preferred examples of the reducing agent include a phenolic compound such as thiosalicylic acid, hydroquinone, metol, methoxyquinone, resorcine, or 2-methylresorcine, and an amine compound such as phenylenediamine or phenylhydrazine. Preferred examples of the inorganic reducing agent include a sodium, potassium or ammonium salt of an inorganic acid such as sodium sulfite, potassium sulfite, ammonium sulfite, sodium phosphite, potassium phosphite, ammonium phosphite, sodium hydrogen phosphite, potassium hydrogen phosphite, ammonium hydrogen phosphite, sodium thiosulfate, potassium thiosulfate, ammonium thiosulfate, sodium dithionite, potassium dithionite, ammonium dithionite. It is sulfite of these that shows excellent anti-staining effect. The reducing agent content of the developer is preferably 0.05 to 5% by weight.

(Organic Carboxylic Acid)

An organic carboxylic acid is optionally added to the developer or developer replenisher used in the invention. Preferred organic carboxylic acids include an aliphatic carboxylic acid or an aromatic carboxylic acid each having a carbon atom number of from 6 to 20. Examples of the aliphatic carboxylic acid include caproic acid, enanthic acid, caprylic acid, lauric acid, myristic acid, palmitic acid, and stearic acid. Particularly preferred are alkanoic acids having a carbon atom number of from 8 to 12. The acid may be an unsaturated acid having a double bond in the molecule or may have a branched carbon chain. The aromatic carboxylic acid is an aromatic compound such as benzene, naphthalene or anthracene having a carboxyl group. Examples of the aromatic carboxylic acid include o-chlorobenzoic acid, p-chlorobenzoic acid, o-hydroxybenzoic acid, p-hydroxybenzoic acid, o-aminobenzoic acid, p-aminobenzoic acid, 2,4-dihydroxybenzoic acid, 2,5-dihydroxybenzoic acid, 2,6-dihydroxybenzoic acid, 2,3-dihydroxybenzoic acid, 3,5-dihydroxybenzoic acid, gallic acid, 1-hydroxy-2-naphthoic acid, 3-hydroxy-2-naphthoic acid, 2-hydroxy-1-naphthoic acid, 1-naphthoic acid, and 2-naphthoic acid. Hydroxy naphthoic acids are especially preferred.

These carboxylic acids are preferably used in the salt form, for example as the sodium salts, potassium salts or ammonium salts, in order to increase the water solubility. The carboxylic acid content of the developer is not specifically limited, but the carboxylic acid content less than 0.1% by weight does not show sufficient effect and the carboxylic acid content more than 10% by weight does not show more improved effect, and may prevent dissolution of another additive in the developer. The carboxylic acid content of the developer is preferably from 0.1 to 10% by weight, and more preferably from 0.5 to 4% by weight.

(Other Additives)

The developer or developer replenisher in the invention may contain the following additives in order to increase development performance. Examples of the additives include a neutral salt such as sodium chloride, potassium chloride, potassium bromide, as dislosed in Japanese Patent O.P.I. Publication No. 58-75152, a complex such as [Co(NH₃)₆]Cl₃ as dislosed in Japanese Patent O.P.I. Publication No. 59-121336, an amphoteric polymer such as a copolymer of vinylbenzyltrimethylammonium chloride and sodium acrylate as disclosed in Japanese Patent O.P.I. Publication No. 56-142258, the organic metal containing surfactant containing Si or Ti as disclosed in Japanese Patent O.P.I. Publication No. 59-75255, and the organic boron containing compound disclosed in Japanese Patent O.P.I. Publication No. 59-84241. The developer or developer replenisher in the invention can further contain an antiseptic agent, a coloring agent, a viscosity increasing agent, an antifoaming agent, or a water softener.

Examples of the antifoaming agent include mineral oil, vegetable oil, alcohols, surfactants, and silicon oil, which are disclosed in Japanese Patent O.P.I. Publication No. 2-244143. The water softeners include polyphosphoric acid or its sodium, potassium or ammonium salt; aminopolycarboxylic acids or their salts such as ethylenediaminetetraacetic acid or its sodium, potassium or ammonium salt, diethylenetriaminepentaacetic acid or its sodium, potassium or ammonium salt, triethylenetetramine-hexaacetic acid or its sodium, potassium or ammonium salt, hydroxyethylethylene-diaminetriacetic acid or its sodium, potassium or ammonium salt, nitrilotriacetic acid or its sodium, potassium or ammonium salt, 1,2-diaminocyclohexane-tetraacetic acid or its sodium, potassium or ammonium salt, 1,3-diamino-2-propanoltetraacetic acid or its sodium, potassium or ammonium salt; and phosphonic acids or their salts such as aminotri(methylenephosphonic acid) or its sodium, potassium or ammonium salt, ethylenediaminetetra(methylenephosphonic acid) or its sodium, potassium or ammonium salt, diethylenetriamine-penta(methylenephosphonic acid) or its sodium, potassium or ammonium salt, triethylenetetraminehexa(methylenephosphonic acid) or its sodium, potassium or ammonium salt, hydroxyethylethylenediaminetri(methylenephosphonic acid) or its sodium, potassium or ammonium salt, and 1-hydroxyethane-1,1-diphosphonic acid or its sodium, potassium or ammonium salt. The water softener content of the developer varies on hardness or amount of a hard water used, but the content is preferably 0.01 to 5 weight %, and more preferably 0.01 to 0.5 weight %. The water softener content less than 0.01% by weight cannot obtain a desired object, while the water softener content less than 5% by weight provides an adverse effect on image portions, such as color elimination. The developer or developer replenisher is an aqueous solution in which water is used as a solvent. The electric conductance of the developer is preferably from 5 to 50 mS.

(Concentrated Solution)

The developer or developer replenisher in the invention is preferably a concentrated solution having a water content -less than that at using, which is to be diluted with water at using, in view of transporting. The degree of concentration is such that components in the concentrated solution are not precipitated nor separated from the solution. It is preferred that the concentrated solution contains a solubilizing agent if necessary. Examples of the solubilizing agent include so-called hydrotropes such as toluene sulfonic acid, xylene sulfonic acid or their alkali metal salt disclosed in Japanese Patent O.P.I. Publication Nos. 6-32081.

Water content of the concentrated solution being further reduced, the concentrated solution can be a concentrate in the solid or paste form. The developer concentrated solution may be prepared by providing a developer solution, followed by evaporation to dryness and is preferably prepared in such a manner that plural components are mixed with a small amount of water or without adding any water. The developer concentrate can also be prepared in the form of granules or tablets, as described in Japanese Patent O.P.I. Publication Nos. 51-61837, 2-109042, 2-109043, 3-39735, 5-142786, 6-266062 and 7-13341. Components contained in the developer concentrate in the solid or paste form can employ those used in the developer of a photopolymerizable light sensitive planographic printing plate material. It is preferred that the developer concentrate in the solid or paste form does not contain a compound, which changes in nature after diluted with water. When the water content of a silicate solution is reduced, the silicate is petrified and difficult to dissolve in water, and therefore, the developer concentrate preferably contains a carbonate, a phosphate or an organic acid salt, instead of a silicate.

The developer concentrated solution or developer concentrate in the solid or paste form may be divided into plural parts differing in material species or compounding ratio. The developer concentrated solution or developer concentrate in the solid or paste form is used for development preferably by diluting with water to a prescribed concentration prior to development. When the developer concentrated solution or developer concentrate is used as a developer replenisher, it is preferred that it is diluted with water to a prescribed concentration, followed by being supplied to a working developer, whereby it is also feasible to supply a developer at a higher concentration than the prescribed one or, without being diluted to the prescribed concentration, to the working developer. When supplied at a higher concentration than the prescribed one or without being diluted to the prescribed concentration, water may be separately added in the same timing or in a different timing.

(Automatic Developing Machine)

It is preferred that the automatic developing machine used invention comprises a means for replenishing a developer replenisher in a necessary amount; a means for discharging any excessive developer; a means for automatically replenishing water in necessary amounts; a means for detecting a transported planographic printing plate material; a means for calculating the area of the planographic printing plate precursor based on the detection; a means for controlling the replenishing amount of a developer replenisher, the replenishing amount of water to be replenished or the replenishing timing; a means for detecting a pH, temperature and/or electric conductivity of developer; or a means for controlling the replenishing amount of the developer replenisher, the replenishing amount of water to be replenished or the replenishing timing based on the detection. Washing water used for washing after development can be used as diluting water for diluting concentrated developer or concentrated developer replenisher.

The automatic developing machine used in the invention may have a pre-processing tank charged with a pre-processing solution upstream the developing means, in which a planographic printing plate material is immersed. It is preferred that this pre-processing tank is equipped with a spray for spraying the pre-processing solution onto the surface of a printing plate material, a means for controlling the temperature of the pre-processing solution to fall within the range of 25 to 55° C., and still more preferably a brush in the roll form for brushing the surface of the printing plate material. As the pre-processing solution, common water is preferably used.

(Post Processing)

The planographic printing plate material developed with the developer described above is subjected to post-processing. The post-processing step comprises post-processing the developed plate material with a post-processing solution such as washing water, a rinsing solution containing a surfactant, a finisher or a protective gumming solution containing gum arabic or starch derivatives as a main component. The post-processing step is carried out employing an appropriate combination of the post-processing solution described above. For example, a method is preferred in which a developed planographic printing plate material is post-washed with washing water, and then processed with a rinsing solution containing a surfactant, or a developed planographic printing plate material is post-washed with washing water, and then processed with a finisher, since it reduces fatigue of the rinsing solution or the finisher. It is preferred that a multi-step countercurrent processing is carried out employing a rinsing solution or a finisher. The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate material to wash the material, and reuses the water used for washing as a dilution water of a concentrated developer. In the automatic developing machine, a method is applied in which each processing solution is replenished with the respective processing replenisher according to the area of the printing plate material to have been processed or the operating time of the machine. A method (use-and-discard method) can be applied in which the developed material is processed with fresh processing solution and discarded. The thus obtained planographic printing plate is mounted on a printing press, and printing is carried out.

(Gumming Solution)

The gumming solution preferably contains an acid or a buffering agent in order to remove an alkali component of the developer from a developed printing plate material, and can contain hydrophilic polymer, a chelating agent, a lubricant, an antiseptic agent, or a solubilizing agent. When the gumming solution contains a hydrophilic polymer, the solution can work as a protector which prevents stain or scratches from occurring in the printing plate material after development.

(Pre-Washing)

In the invention, the exposed planographic printing plate material before development is preferably pre-washed with washing water. The washing water is usually water, and may be an aqueous solution in which an additive is added to water. In the invention, the planographic printing plate material may be developed immediately after pre-washed or after washed and dried. After development, the planographic printing plate material can be subjected to known post processing including washing, rinsing or gumming treatment. The used washing water before development can be reused in washing water to be used after development, a rinsing solution or a gumming solution.

(Printing)

Thus, the planographic printing plate material is subjected to the developing treatment described above to obtain a planographic printing plate with an image. The resulting planographic printing plate is mounted on a press, and then printing is carried out. In printing, a printing press, printing paper, printing ink and a dampening solution are not specifically limited. In recent years, printing ink containing no petroleum volatile organic compound (VOC) has been developed and used in view of environmental concern. The present invention provides excellent effects in employing such a printing ink. Examples of such a printing ink-include soybean oil ink “Naturalith 100” produced by Dainippon Ink Kagaku Kogyo Co., Ltd, VOC zero ink “TK HIGH ECO NV” produced by Toyo Ink Manufacturing Co., Ltd., and process ink “Hicelvo” produced by Tokyo Ink Co., Ltd.

The soybean oil-based ink used in the invention contains soybean oil of from 1 to 20% by weight.

### EXAMPLES

Next, the present invention will be explained employing examples, but the present invention is not limited thereto. In the examples, “parts” represents “parts by weight”, unless otherwise specified.

### Example 1

(Preparation of Supports)

Preparation of Support A (Inventive)

Employing a continuous aluminum plate processing apparatus, a 0.24 mm thick aluminum (according to JIS 1050) plate was degreased at 60° C. for 10 seconds in a 5% sodium hydroxide solution, washed with water, immersed at 25° C. for 10 seconds in a 10% nitric acid solution to neutralize, and then washed with water. The aluminum plate was electrolytically surface roughened at 30° C. for 20 seconds at a current density of 50 A/dm² in an aqueous solution containing 11 g/liter of hydrochloric acid, 12 g/liter of acetic acid, and 1.5 g/liter of dissolved aluminum, immersed in a 1% sodium hydroxide solution at 20° C. for 10 seconds, further immersed in a 10% nitric acid solution at 25° C. for 10 seconds to neutralize, and then washed with water.

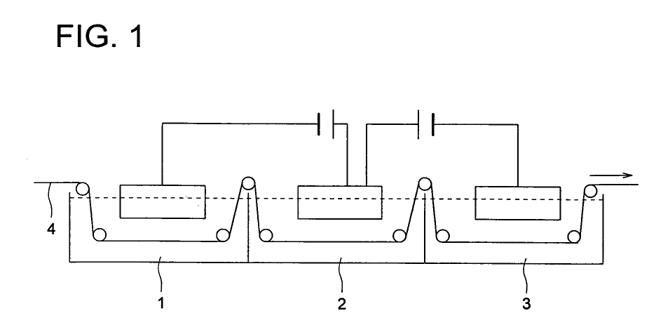

The surface roughened aluminum plate was anodized employing an anodization apparatus as shown in FIG. 1. In FIG. 1, numerical number 1 represents a phosphoric acid electrolysis tank, numerical number 2 represents an electrolytic tank, numerical number 3 represents a sulfuric acid electrolysis tank, and numerical number 4 represents an aluminum plate. The surface roughened aluminum plate was anodized in a 30% phosphoric acid aqueous solution at 30° C. for 30 seconds at a current density of 5 A/dm² to form a phosphoric acid anodization layer with a thickness of 0.3 μm, passed through an electrolytic tank charged with a 20% sulfuric acid aqueous solution, further anodized in a 20% sulfuric acid aqueous solution at 30° C. for 30 seconds at a current density of 7 A/dm² to form a sulfuric acid anodization layer with a coating amount of 2.5 g/m² (0.9 μm), and washed with water. In the anodization layers formed as above, the phosphoric acid anodization layer, which is formed earlier, is formed on the sulfuric acid anodization layer to be formed later. This is due to the fact that since an anodization layer grows on the surface of an aluminum plate (not on an anodization layer), an earlier formed anodization layer is formed on a later formed anodization layer.

Successively, the resulting aluminum plate was immersed in a 0.2% polyvinyl phosphonic acid aqueous solution at 70° C. for 30 seconds, washed with water, and dried at 50-230° C. Thus, Support A was prepared.

Preparation of Support B (Inventive)

Support B was prepared in the same manner as in Support A above, except that the surface roughened aluminum plate was anodized in a 30% phosphoric acid aqueous solution at 30° C. for 30 seconds at a current density of 1 A/dm² to form a phosphoric acid anodization layer with a coating thickness of 0.1 μm.

Preparation of Support C (Comparative)

Support C was prepared in the same manner as in Support A above, except that the surface roughened aluminum plate was anodized in a 20% sulfuric acid aqueous solution in place of the 30% phosphoric acid aqueous solution to form a sulfuric acid anodization layer with a coating thickness of 2.5 g/m².

Preparation of Support D (Comparative)

Support D was prepared in the same manner as in Support A above, except that the aluminum plate, which was anodized in the 30% phosphoric acid aqueous solution at 30° C. for 30 seconds at a current density of 5 A/dm², was passed through an electrolytic tank charged with a 30% phosphoric acid aqueous solution in place of the 20% sulfuric acid aqueous solution, and then anodized in a 30% phosphoric acid aqueous solution in place for the 20% sulfuric acid aqueous solution at 30° C. for 5 minutes at a current density of 7 A/dm² to form a phosphoric acid anodization layer with a coating amount of 1.5 g/m².

The photograph of the section of Support A or B shows apparent two layers comprised of the phosphoric acid anodization layer and the sulfuric acid anodization layer.

(Preparation of Photopolymer Type Planographic Printing Plate Material Samples 1 through 4 for a FD-YAG Laser (532 nm) Source)

The following photopolymerizable light sensitive layer coating solution was coated on each of Supports A, B, C and D through a wire bar, and dried at 95° C. for 1.5 minutes to give a photopolymerizable light sensitive layer having a dry thickness of 1.5 g/m². After that, the following protective layer coating solution was coated on the photopolymerizable light sensitive layer using an applicator, and dried at 75° C. for 1.5 minutes to give a protective layer with a dry thickness of 2.0 g/m². Thus, planographic printing plate material samples with the protective layer were prepared.

(Photopolymerizable light sensitive layer coating solution)

| | | |
|---|---|---|
| Polymer binder B-1 (as prepared below) | 40.0 | parts |
| Mixture of sensitizing dyes D-1 and D-2 (1:1) | 3.0 | parts |
| Photopolymerization initiator, | 4.0 | parts |
| η-cumene-(η-cyclopentadienyl) iron hexafluorophosphate | | |
| Addition polymerizable ethylenically | 40.0 | parts |
| unsaturated monomer M-3 (described previously) | | |
| Addition polymerizable ethylenically | 15.0 | parts |
| unsaturated monomer NK ESTER G (polyethylene | | |
| glycol, produced by Shinnakamura Kagaku Co., Ltd.) | | |
| Hindered amine compound | 0.1 | parts |
| (LS-770 produced by Sankyo Co., Ltd.) | | |
| Trihaloalkyl compound E-1 shown below | 1.0 | part |
| Phthalocyanine pigment | 4.0 | parts |
| (MHI #454 produced by Mikuni Sikisosha) | | |
| Fluorine-contained surfactant | 0.5 | parts |
| (F-178K produced by Dainippon Ink Kagaku | | |
| Kogyo Co., Ltd.) | | |
| Methyl ethyl ketone | 80 | parts |
| Cyclohexanone | 820 | parts |

(Synthesis of Polymer Binder B-1)

125 parts (1.25 mol) of methyl methacrylate, 12 parts (0.1 mol) of ethyl methacrylate, 63 parts (0.73 mol) of methacrylic acid, 240 parts of cyclohexanone, 160 parts of isopropyl alcohol, and 5 parts of α,α′-azobisisobutyro-nitrile were put in a three neck flask under nitrogen atmosphere, and reacted under nitrogen atmosphere for 6 hours at 80° C. in an oil bath. After that, 4 parts of triethylbenzylammonium chloride and 52 parts (0.73 mol) of glycidyl methacrylate were further added to the mixture, and reacted at 25° C. for 3 hours. Thus, polymer binder B-1 was obtained. The weight average molecular weight of the polymer binder B-1 was 55,000 (in terms of polystyrene), measured according to GPC.

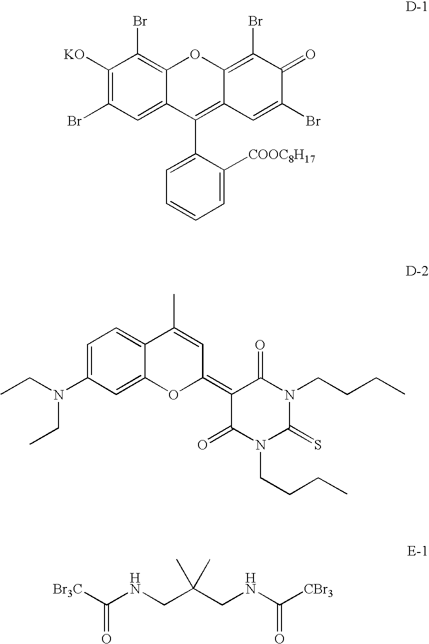

(Protective Layer Coating Solution)

| | |
|---|---|
| Polyvinyl alcohol (GL-05, produced | 84 parts |
| by Nippon Gosei Kagaku Co., Ltd.) | |
| Polyvinyl pyrrolidone (K-30, produced | 15 parts |
| by ISP Japan Co., Ltd.) | |
| Surfactant (Surfinol 465, | 0.5 parts |
| produced by Nisshin Kagaku Kogyo Co., Ltd.) | |
| Water | 900 parts |

(Image Formation)

The planographic printing plate material sample obtained above was imagewise exposed at an exposure of 200 μJ/cm² and at a resolving degree of 2400 dpi, employing a CTP exposure device Tigercat (produced by ECRM Co., Ltd.) in which a FD-YAG laser was installed to obtain an image with a screen number of 175. Herein, dpi represents the dot numbers per 2.54 cm. The image pattern used for the exposure comprised a solid image and a dot image with 1 to 99% dot area. Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with developer having the following developer composition, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 1 through 4 were obtained. Herein, preheating was carried out at a surface temperature of 115° C. for 15 seconds. Time taken from completion of exposure till to arrival at the preheating section was within 30 seconds.

<Developer Composition>

| | |
|---|---|
| Potassium silicate solution | 40.0 g/liter |
| (containing 26% by weight of SiO₂ and | |
| 13.5% by weight of K₂O) | |
| Potassium hydroxide | 4.0 g/liter |
| Ethylenediaminetetraacetic acid | 0.5 g/liter |
| Sodiumsulfo-polyoxyethylene (13) | 20.0 g/liter |
| naphthyl ether | |

Water was added to make a 1 liter developer. PH of the developer was 12.3.

(Printing Method)

The planographic printing plate material sample was imagewise exposed and developed as above to obtain a planographic printing plate sample. Employing the resulting printing plate sample, printing was carried out on a press (DAIYAlF-1 produced by Mitsubishi Jukogyo Co., Ltd.), wherein a coat paper, printing ink (soybean oil-based ink “Naturalist 100” produced by Dainippon Ink Kagaku Kogyo Co., Ltd.), and dampening water (SG-51, H solution produced by Tokyo Ink Co., Ltd., Concentration: 1.5%) were used.

(Printing Durability)

The maximum number of prints printed from the beginning of the printing till when the 3% dot area was not reproduced was determined and evaluated as a measure of printing durability.

The more the maximum number is, the higher printing durability. The results are shown in Table 1.

(Anti-Stain Property)

Printing was carried out obtain one hundred printed sheets. The non-image portions of the one hundredth printed sheet was visually evaluated according to the following criteria:

TABLE 1

| | | Printing | | |
|---|---|---|---|---|
| Printing | Support | durability | Anti-stain | |
| plate No. | No. | (Number) | property | Remarks |
| 1 | A | 300,000 | B | Inventive |
| 2 | B | 400,000 | B | Inventive |
| 3 | C | 100,000 | A | Comparative |
| 4 | D | 600,000 | C | Comparative |

A: No stain observed.
B: Slight stain was observed, but was not practically problematic.
C: Apparent stain was observed, and was practically problematic.

As is apparent from Table 1 above, inventive planographic printing plate material samples provide high printing durability and excellent anti-stain property.

(Preparation of Photopolymer Type Planographic Printing Plate Material Samples 5 through 8 for a Violet Light)

The following photopolymerizable light sensitive layer coating solution was coated on each of Supports A, B, C and D through a wire bar, and dried at 95° C. for 1.5 minutes to give a photopolymerizable light sensitive layer having a dry thickness of 1.5 g/m². After that, the following protective layer coating solution was coated on the photopolymerizable light sensitive layer using an applicator, and dried at 75° C. for 1.5 minutes to give a protective layer with a dry thickness of 2.0 g/m². Thus, planographic printing plate material samples with the protective layer were prepared.

Photopolymerizable Light Sensitive Layer Coating Solution)

| | | |
|---|---|---|
| Polymer binder B-1 | 40.0 | parts |
| Photopolymerization initiator, | 3.0 | parts |
| η-cumene- (η-cyclopentadienyl) iron | | |
| hexafluorophosphate | | |
| Mixture of sensitizing dyes D-3 and D-4 | 4.0 | parts |
| as shown below (1:1) | | |
| Addition polymerizable ethylenically | 40.0 | parts |
| unsaturated monomer M-3 (described above) | | |
| Addition polymerizable ethylenically | 7.0 | parts |
| unsaturated monomer NK ESTER G (polyethylene | | |
| glycol dimethacrylate, produced by | | |
| Shinnakamura Kagaku Co., Ltd.) | | |
| Cationically polymerizable monomer | 8.0 | parts |
| C-1 as shown below | | |
| Hindered amine compound | 0.1 | parts |
| (LS-770 produced by Sankyo Co., Ltd.) | | |
| Trihaloalkyl compound E-l described above | 5.0 | part |
| Phthalocyanine pigment | 7.0 | parts |
| (MHI #454 produced by Mikuni Sikisosha) | | |
| Fluorine-contained surfactant | 0.5 | parts |
| (F-178K produced by Dainippon Ink | | |
| Kagaku Kogyo Co., Ltd.) | | |
| Methyl ethyl ketone | 80 | parts |
| Cyclohexanone | 820 | parts |
| D-3 | | |
| 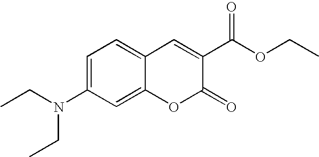 | | |
| D-4 | | |
| 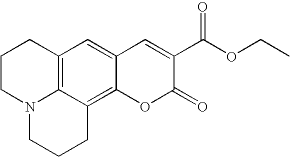 | | |
| C-1 | | |
| 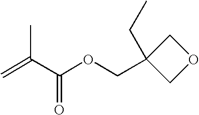 | | |

(Image Formation)

Employing a plate setter Tigercat (produced by ECRM Co., Ltd.), in which a 408 nm laser with an output power of 30 mW was installed, the planographic printing plate material sample obtained above was imagewise exposed at an exposure of 50 μJ/cm² and at a resolving degree of 2400 dpi to obtain an image with a screen number of 175. The image pattern used for the exposure comprised a solid image and a dot image with 1 to 99% dot area. Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with the developer described above, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 25 through 48 were obtained. Herein, preheating was carried out at a surface temperature of 115° C. for 15 seconds. Time taken from completion of exposure till to arrival at the preheating section was within 30 seconds.

(Printing Method, Printing Durability, and Anti-Stain Property)

Printing was carried out in the same manner as above, and printing durability and anti-stain property were evaluted according to the same method as described above. The results are shown in Table 2.

TABLE 2

| | | Printing | | |
|---|---|---|---|---|
| Printing | Support | durability | Anti-stain | |
| plate No. | No. | (Number) | property | Remarks |
| 5 | A | 300,000 | B | Inventive |
| 6 | B | 400,000 | B | Inventive |
| 7 | C | 100,000 | A | Comparative |
| 8 | D | 600,000 | C | Comparative |

As is apparent from Table 2 above, inventive planographic printing plate material samples provide high printing durability and excellent anti-stain property.

(Preparation of Photopolymer Type Planographic Printing Plate Material Samples 9 through 12 for Infrared Laser (830 nm) Source)

The following photopolymerizable light sensitive layer coating solution was coated on each of supports A, B, C, and D through a wire bar, and dried at 95° C. for 1.5 minutes to give a photopolymerizable light sensitive layer having a dry thickness of 1.5 g/m². After that, the protective layer coating solution described above was coated on the photopolymerizable light sensitive layer using an applicator, and dried at 75° C. for 1.5 minutes to give a protective layer with a dry thickness of 2.0 g/m². Thus, planographic printing plate material samples with the protective layer were prepared.

(Photopolymerizable Light Sensitive Layer Coating Solution)

| | | |
|---|---|---|
| Polymer binder B-1 | 40.0 | parts |
| Infrared absorbing dye D-5 | 2.5 | parts |
| N-Phenylglycine benzyl ester | 4.0 | parts |
| Addition polymerizabie ethylenically | 40.0 | parts |
| unsaturated monomer M-3 | | |
| Addition polymerizable ethylenically | 7.0 | parts |
| unsaturated monomer NK ESTER G (polyethylene | | |
| glycol dimethacrylate, produced by Shinnakamura | | |
| Kagaku Co., Ltd.) | | |
| Cationically polymerizable monomer C-1 | 8.0 | parts |
| Hindered amine compound | 0.1 | parts |
| (LS-770 produced by Sankyo Co., Ltd.) | | |
| Trihaloalkyl compound E-1 | 5.0 | part |
| Phthalocyanine pigment | 7.0 | parts |
| (MHI #454 produced by Mikuni Sikisosha) | | |
| Fluorine-contained surfactant | 0.5 | parts |
| (F-178K produced by Dainippon Ink Kagaku | | |
| Kogyo Co., Ltd.) | | |
| Methyl ethyl ketone | 80 | parts |
| Cyclohexanone | 820 | parts |

D-5

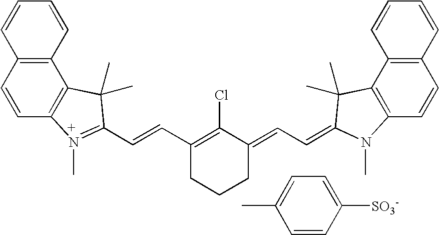

(Image Formation)

Employing a plate setter Trend Setter 3244 (produced by Creo Co., Ltd.), in which a 830 nm laser was installed, the planographic printing plate material sample obtained above was imagewise exposed at an exposure of 200 mJ/cm² and at a resolving degree of 2400 dpi to obtain an image with a screen number of 175. The image pattern used for the exposure comprised a solid image and a dot image with 1 to 99% dot area. Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with the developer described above, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 9 through 12 were obtained. Herein, preheating was carried out at a surface temperature of 115° C. for 15 seconds. Time taken from completion of exposure till to arrival at the preheating section was within 30 seconds.

(Printing Method, Printing Durability, and Anti-Stain Property)

Printing was carried out in the same manner as above, and printing durability and anti-stain property were evaluated according to the same method as described above. The results are shown in Table 3.

TABLE 3

| | | Printing | | |
|---|---|---|---|---|
| Printing | Support | durability | Anti-stain | |
| plate No. | No. | (Number) | property | Remarks |
| 9 | A | 250,000 | B | Inventive |
| 10 | B | 350,000 | B | Inventive |
| 11 | C | 150,000 | A | Comparative |
| 12 | D | 500,000 | C | Comparative |

As is apparent from Table 3 above, inventive planographic printing plate material samples provide high printing durability and excellent anti-stain property.

(Preparation of Positive Working Planographic Printing Plate Material Samples 13 through 16 for Infrared Laser (830 nm) Source)

The following light sensitive layer coating solution was coated on each of supports A, B, C, and D through a wire bar, and dried at 95° C. for 1.5 minutes to give a light sensitive layer having a dry thickness of 1.5 g/m². Thus, planographic printing plate material samples were prepared.

(Light Sensitive Layer Coating Solution)

| | | |
|---|---|---|
| Novolac resin (m-cresol-p-cresol (60/40) | 1.0 | part |
| novolac resin containing having an unreacted cresol | | |
| content of 0.5% by weight and a weight average molecular | | |
| weight of 7,000) | | |
| Infrared absorbing dye D-5 | 0.1 | parts |
| Tetrahydrophthalic anhydride | 0.05 | parts |
| p-Toluene sulfonic acid | 0.002 | parts |
| Ethyl violet in which Cl⁻ was substituted | 0.02 | parts |
| with 6-hydroxy-β-naphthalene sulfonate ion | | |
| Fluorine-contained surfactant | 0.5 | parts |
| (F-178K produced by Dainippon Ink Kagaku | | |
| Kogyo Co., Ltd.) | | |
| Methyl ethyl ketone | 12 | parts |

Employing a plate setter Trend Setter 3244 (produced by Creo Co., Ltd.), in which a 830.nm laser was installed, the planographic printing plate material sample obtained above was imagewise exposed at an exposure of 150 mJ/cm² and at a resolving degree of 2400 dpi to obtain an image with a screen number of 175. The image pattern used for the exposure comprised a solid image and a dot image with 1 to 99% dot area. Subsequently, the exposed sample was subjected to development treatment employing a CTP automatic developing machine (PHW 23-V produced by Technigraph Co., Ltd.) to obtain a planographic printing plate. Herein, the developing machine comprised a preheating section for preheating the exposed sample, a pre-washing section for removing the protective layer before development, a development section charged with the following developer, a washing section for removing the developer remaining on the developed sample after development, and a gumming section charged with a gumming solution (a solution obtained by diluting GW-3, produced by Mitsubishi Chemical Co., Ltd., with water by a factor of 2) for protecting the surface of the developed sample. Thus, planographic printing plate samples 13 through 16 were obtained. Herein, the preheating section switched off, preheating was not carried out, and washing water for removing a protective layer was not supplied to the pre-washing section. Time taken from completion of exposure till to arrival at the preheating section was within 30 seconds.

<Developer>

| | |
|---|---|
| Potassium salt of nonreducing sugar | 50 g/liter |
| (formed from D-sorbit and K₂O) | |
| OLFINE AK-02 | 0.15 g/liter |
| (produced by Nissin Kagaku Co., Ltd.) | |
| C₁₂H₂₅N(CH₂CH₂COONa)₂ | 1.0 g/liter |

Water was added to make a 1 liter developer. (Printing Method, Printing Durability, and Anti-Stain Property)

Printing was carried out in the same manner as above, printing durability and anti-stain property were related according to the same method as described above. results are shown in Table 4.

TABLE 4

| | | Printing | | |
|---|---|---|---|---|
| Printing | Support | durability | Anti-stain | |
| plate No. | No. | (Number) | property | Remarks |
| 13 | A | 150,000 | B | Inventive |
| 14 | B | 250,000 | B | Inventive |
| 15 | C | 80,000 | A | Comparative |
| 16 | D | 300,000 | C | Comparative |

As is apparent from Table 4 above, inventive planographic printing plate material samples provide high printing durability and excellent anti-stain property. (Preparation of On-Press Development Type Planographic Printing Plate Material Samples 17 through 20 for Infrared Laser (830 nm) Source)

(Hydrophilic Layer)

The following materials were sufficiently mixed while stirring, employing a homogenizer, and filtered to obtain a hydrophilic layer coating solution with a solid content of 15% by weight. Then, the hydrophilic layer coating solution was coated on each of supports A, B, C, and D obtained above with a wire bar, dried at 100° C. for 3 minutes to obtain a hydrophilic layer with a dry thickness of 2.0 g/m², and further subjected to aging at 60° C. for 24 hours.

(Hydrophilic Layer Coating Solution)

| | |
|---|---|
| Metal oxide particles having a light-to-heat conversion | 12.50 parts |
| capability, | |
| Black iron oxide particles ABL-207 | |
| (produced by Titan Kogyo K. K., octahedral form, average | |
| particle diameter: 0.2 μm, specific surface area: 6.7 m²/g, | |
| Hc: 9.95 kA/m, σs: 85.7 Am²/kg, σr/σs: 0.112) | |
| Colloidal silica (alkali type): | 60.62 parts |
| Snowtex XS (solid content: 20% by weight, produced | |
| by Nissan Kagaku Co., Ltd.) | |
| Aqueous 10% by weight sodium phosphate | 1.13 parts |
| dodecahydrate solution (Reagent produced by Kanto | |
| Kagaku Co., Ltd.) | |
| Aqueous 10% by weight solution of | 2.50 parts |
| water-soluble chitosan Flownack S (produced by | |
| Kyowa Technos Co., Ltd.) | |
| Aqueous 1% by weight solution of | 1.25 parts |
| Surfactant Surfinol 465 (produced by Air Products | |
| Co., Ltd.) | |
| Pure water | 22.00 parts |

Subsequently, the following image formation layer coating solution was coated on the hydrophilic layer, employing a wire bar, dried at 55° C. for 3 minutes to give an image formation layer with a dry thickness of 1.50 g/m², and further subjected to aging at 40° C. for 24 hours.

(Image Formation Layer Coating Solution)

| | |
|---|---|
| Aqueous polyurethane Takelac W-615 | 17.1 parts |
| (solid content: 35% by weight, produced by Mitsui Takeda | |
| Chemical Co., Ltd.) | |
| Aqueous block isocyanate Takenate | 7.1 parts |
| XWB-72-N67 (solid content: 45% by weight, produced by | |
| Mitsui Takeda Chemical Co., Ltd.) | |
| Aqueous solution (solid content: | 5.0 parts |
| 10% by weight) of sodium acrylate Aqualic DL522 | |
| (produced by Nippon Shokubai Co., Ltd.) | |
| Ethanol solution (solid content: | 30.0 parts |
| 1% by weight) of light-to-heat conversion dye ADS 830AT | |
| (produced by American Dye Source Co., Ltd.) | |
| Pure water | 40.8 parts |

(Image Formation)

Employing a plate setter Trend Setter 3244 (produced by Creo Co., Ltd.), in which a 830 nm laser was installed, the planographic printing plate material sample obtained above was imagewise exposed at an exposure of 250 mJ/cm² and at a resolving degree of 2400 dpi to obtain an image with a screen number of 175. The image pattern used for the exposure comprised a solid image and a dot image with 1 to 99% dot area. Thus, planographic printing plate samples 17 through 20 were obtained.

(Printing Method)

The planographic printing plate material sample was imagewise exposed as above to obtain a planographic printing plate sample. Employing the exposed printing plate sample, printing was carried out on a press (DAIYAlF-1 produced by Mitsubishi Jukogyo Co., Ltd.), wherein a coat paper, printing ink (soybean oil-based ink “Naturalist 100” produced by Dainippon Ink Kagaku Kogyo Co., Ltd.), and dampening water (SG-51, H solution produced by Tokyo Ink Co., Ltd., Concentration: 1.5%) were used.

(Printing Durability and Anti-Stain Property)

Printing durability and anti-stain property were evaluated according to the same method as described above. The results are shown in Table 5.

TABLE 5

| | | Printing | Anti- | |
|---|---|---|---|---|
| Printing | Support | durability | stain | |
| plate No. | No. | (Number) | property | Remarks |
| 17 | A | 140,000 | B | Inventive |
| 18 | B | 180,000 | B | Inventive |
| 19 | C | 20,000 | A | Comparative |
| 20 | D | 250,000 | C | Comparative |

As is apparent from Table 5 above, inventive planographic printing plate material samples provide high printing durability and excellent anti-stain property.

What is claimed is:

1. An aluminum support for a planographic printing plate comprising an electrolytically surface-roughened aluminum plate, and a sulfuric acid anodization layer and a phosphoric acid anodization layer provided in that order on the surface-roughened surface of the surface-roughened aluminum plate, the sulfuric acid anodization layer having micro-pores with a pore size of from 8 to 15 nm and the phosphoric acid anodization layer having micro-pores with a pore size of from 40 to 100 nm, wherein the sulfuric acid anodization layer has been formed by anodizing the aluminum plate in a sulfuric acid electrolytic solution and the phosphoric acid anodization layer has been formed by anodizing the aluminum plate in a phosphoric acid electrolytic solution.

2. The aluminum support of claim 1, wherein the phosphoric acid anodization layer has a thickness of from 0.1 to 0.5 μm.

3. The aluminum support of claim 1, wherein the sulfuric acid anodization layer has a thickness of from 0.5 to 1.0 μm.

4. A planographic printing plate material comprising the aluminum support of claim 1, and provided thereon, an image formation layer.

5. The planographic printing plate material of claim 4, wherein the image formation layer is a positive-working or negative working image formation layer.

6. The planographic printing plate material of claim 5, wherein the image formation layer is a positive-working image formation layer.

7. The planographic printing plate material of claim 5, wherein the image formation layer is a negative-working image formation layer.

8. The planographic printing plate material of claim 7, wherein the negative-working image formation layer is a photopolymerizable light sensitive layer containing a photopolymerizable monomer and an initiator.

9. The planographic printing plate material of claim 4, wherein the image formation layer is an image formation layer capable of being developed on a printing press.

10. A process for manufacturing an aluminum support for a planographic printing plate material, the process comprising the steps of:
(a) electrolytically surface-roughening an aluminum plate;
(b) anodizing the electrolytically surface-roughened aluminum plate in a phosphoric acid electrolytic solution;
(c) treating the resulting aluminum plate in an electrolyte in an electrolyte tank while supplying electric current; and
(d) further anodizing the above-treated aluminum plate in a sulfuric acid electrolytic solution.

11. The process of claim 10, wherein the electrolyte in the electrolyte tank is a phosphoric acid solution or a sulfuric acid solution.

12. The process of claim 11, wherein the electrolyte is a sulfuric acid solution.

13. The process of claim 12, wherein the sulfuric acid solution has an sulfuric acid concentration of from 10 to 50% by weight.

14. The process of claim 10, wherein treating in the step (c) is carried out at a temperature of from 25 to 50° C. at a current density of 30 from to 100 A/dm².

15. An image formation process comprising imagewise exposing to a laser the planographic printing plate material of claim 4.
